(19) United States
(12) Patent Application Publication
(10) Pub. No.: US 2025/0282053 A1
(43) Pub. Date: Sep. 11, 2025

(54) Robotic Arm And Manipulator For Robotically Articulated Work on Conductor Networks

(71) Applicant: Quanta Associates, L.P., Houston, TX (US)

(72) Inventors: David Karl WABNEGGER, La Grange, TX (US); Trevor Stanley JOHNSON, La Grange, TX (US); Benjamin James HARVEY, Cape Coral, FL (US)

(73) Assignee: Quanta Associates, L.P., Houston, TX (US)

(21) Appl. No.: 19/076,338

(22) Filed: Mar. 11, 2025

Related U.S. Application Data
(60) Provisional application No. 63/563,770, filed on Mar. 11, 2024.

(30) Foreign Application Priority Data
Mar. 11, 2024 (CA) 3231687

(51) Int. Cl. B25J 9/16; B25J 11/00; B25J 19/02; B25J 19/06

(52) U.S. Cl. CPC B25J 9/1682; B25J 11/008; B25J 19/02; B25J 19/06

(57) ABSTRACT

The present disclosure relates generally to systems, apparatuses, and methods for repairing or maintaining an electrical component connected to a conductor. In one embodiment, a robot system is disclosed, comprising: a sensor package, a robot, a mechanical translator, and at least one insulator. The sensor package may be configured to sense at least one parameter. The robot may comprise: one or more robotic manipulator arms pivotally connected to the robot and a logic unit configured to control the one or more robotic manipulator arms to perform a repair or maintenance operation. The mechanical translator may be configured to position the robot along a slide rail. The at least one insulator may be configured to releasably secure the conductor away from the electrical component. The system may be mountable to an upper end of a truck or a crane boom. The one or more robotic manipulator arms may be positioned downwardly relative to the slide rail.

### CROSS-REFERENCE TO RELATED APPLICATIONS

This disclosure claims priority to U.S. Provisional Application No. 63/563,770, titled “ROBOTIC ARM AND MANIPULATOR FOR ROBOTICALLY ARTICULATED WORK ON CONDUCTOR NETWORKS,” filed Mar. 11, 2024, and to Canadian Patent Application No. 3,231,687, titled “ROBOTIC ARM AND MANIPULATOR FOR ROBOTICALLY ARTICULATED WORK ON CONDUCTOR NETWORKS,” filed Mar. 11, 2024. The entire contents of the aforementioned applications are incorporated by reference herein for all purposes.

### TECHNICAL FIELD

This disclosure generally relates to performing repair or maintenance operations on conductor networks. More particularly, and without limitation, the present disclosure relates to innovative robotic manipulator arms configured to perform repair or maintenance operations for insulators of conductor networks. Certain aspects of the present disclosure generally relate to systems and methods for robotically manipulating components on conductor networks, such as tie wires for securing a conductor onto an insulator, including a system having a robotic manipulator arm on a robot slidably mounted for sliding translation along an inverted robotic arm which is mounted on a downwardly cantilevered arm extending from the upper end of a truck or crane boom so as to position the robotic manipulator arm.

### BACKGROUND

Many electric power transmission and distribution systems utilize conductors to transmit electrical energy along distances. In some overhead systems, the conductors are suspended or otherwise supported by one or more towers or poles above the ground. Further, some systems include insulators, including pin insulators, strain insulators, and suspension insulators, which are connected to conductors to provide support and/or electrical insulation. Such insulators may require maintenance or repair over their lifespan. During maintenance or repair of insulators, the connected conductors may need to be supported or otherwise securely moved to provide a safe work environment around the insulator. However, the work environment may still permit a lineman to cross a limit of approach, potentially endangering the lineman.

U.S. Pat. Nos. 5,538,207, 8,226,069, 8,585,020, 9,038,989, 8,684,333 and 9,203,219, all of which are incorporated herein by reference in their entireties, describe robotic arms, which may include LineMaster™ robotic arms, for temporarily supporting live conductors. LineMaster™ robotic arms typically include a telescoping linear beam, on which upstanding station-class electrical insulators are mounted to temporarily support the phases of high voltage live conductors. The robotic arm may be mounted on the end of a truck or crane boom, for example, using a boom adapter mounted on the end of the boom. The main beam of the robotic arm is electrically insulated from the truck or crane boom with a fiberglass or otherwise non-electrically conductive section, collectively referred to herein as a “jib.” A jib may be mounted to the boom adapter, in between the boom adapter and the beam. The live conductors are electrically insulated from the beam by the upstanding insulators. An actuator cooperates between the main beam and the boom adapter, for example by means of a direct linkage or a scissor linkage, to rotate the main beam between a horizontal position and a vertically upright position. The insulators are typically at 90 degrees to the beam, although in some embodiments the insulators on the ends of the beam may be inclined outwardly of the beam, for example at 45 degrees. Rotating the main beam also rotates the upstanding insulators between their vertically upstanding position when the beam is horizontal, and a horizontal position when the beam is vertical.

Using a LineMaster™ robotic arm, when it is desired to, for example, replace a powerline structure or insulators, in one method the conductor phases are picked up by the corresponding insulators on the robotic arm and lifted a required distance away from their original position. The picking up, so-called “picking,” of the conductor phases may be done whether the phases are arranged horizontally relative to one another or are arranged vertically relative to one another as the LineMaster™ robotic arm may be rotated into the corresponding orientation.

Although the conventional range of travel of the LineMaster™ robotic arm is only between substantially vertical and horizontal, U.S. patent publication number US 2021/0273424 A1, which published on Sep. 2, 2021, and is incorporated herein by reference in its entirety, discloses that the robotic arm, with conversion to add a new structure such as the disclosed downwardly inclined cantilevered swing arm, may be inverted so as to extend the insulators on the robotic arm vertically downwardly from the beam of the robotic arm. Inverting the robotic arm so as to position the insulators vertically downwardly is used, in the example given, to position and support corresponding electrical switch bypasses.

The prior art, however, lacks a solution that integrates a robotic manipulator arm with a robotic arm so that when the robotic arm is used to pick up conductors, such as the three conductors of a three phase circuit, the integrated robotic manipulator arm may perform what have conventionally been labor-intensive tasks for a lineman, such as affixing the conductors to the insulators on distribution network poles using tie wires or changing the insulators to replace old insulators with new insulators.

A news article published online by The Drive (thedrive.com) on May 5, 2022, entitled “Japan Has a Humanoid Robot That Fixes High-Voltage Train Lines” authored by Victoria Scott (“The Drive Article”). The Drive Article discloses a robot with articulated arms, claw-like hands, and “eyes” in the form of wide-view cameras designed to perform linework on high-voltage train lines.

A research article entitled “Intelligent power distribution live-line operation robot systems based on stereo camera” authored by Yutao Chen, Yahao Wang, Xuming Tang, Kai Wu, Shaolei Wu, Rui Guo, Yu Feng, and Erbao Dong and first published on Jul. 27, 2023 (https://doi.org/10.1049/hve2.12349), discloses an intelligent power distribution live-line operation robot system based on a stereo camera designed to perform linework.

An article published on Apr. 26, 2021, by Power Technology Research entitled “Emergence of Robotics & Drones for Transmission Line Maintenance” and authored by Muhammad Abdullah, discloses the benefits of using robots and drones to perform regular maintenance work on transmission lines.

In addition, U.S. Pat. No. 11,717,969, entitled “Cooperative High-Capacity and High-Dexterity Manipulators,” which issued on Aug. 8, 2023, to Altec Industries, Inc., describes systems and methods for cooperative aerial robotics for working in an aerial environment. A robot system is disclosed which includes a robot unit having high dexterity manipulators and high weight load capacity manipulators. A plurality of sensors detect the work environment for the operation of the robot by an operator, or for operation of the robot automatically or autonomously. The robot system may be disposed at the top of a boom of an aerial device for performing work in high-voltage areas. One embodiment is described as employing a six or more degree of freedom robot unit configured with high-dexterity manipulators. The robot unit may be configured and adapted for performing movements or actions directed to sophisticated, delicate, or fine-tuning work such as untying tie wire, cutting wire, and/or manipulating fasteners.

### SUMMARY

The apparatus according to one aspect of the present disclosure provides a robot having at least one robotic manipulator arm. The robot is mounted on a beam of the robotic arm. The robotic arm may be a LineMaster™ robotic arm or other remotely operable or autonomously-controlled robotic arm. The robotic arm, and in particular the LineMaster™ robotic arm, may advantageously for some applications, such as the removal and installing of tie wires application described as an example herein, be in an inverted position such that approach to the work area, for example the approach to the insulators on the cross arm of a distribution network pole, is done from above. Approach from above provides for positioning of the robot and its at least one robotic manipulator arms into proximity with, and for work on, for example, live conductors, insulators, or tie wires without an operator encroaching the various associated limits of approach. The robotic manipulator arms may perform repetitive tasks such as the removal, for example by cutting or unwrapping, and then tying of tie wires to replace an insulator secured to the live conductors, for example on a distribution network pole.

The robotic arm may include a beam. The robotic arm may be adapted to orient or maintain the beam in a substantially horizontal orientation. For applications, such as described herein, where the robotic arm is inverted so as to position vertically downwardly extending electrical insulators mounted along the beam, the robotic arm may be mounted to the upper end of a boom using a swing arm. The at least one manipulator arm may, for example, include a pair of manipulator arms, laterally spaced apart on the body of the robot. Again, as described in the example herein, a slide rail is mounted along and spaced from the beam. The robot is mounted on, for sliding translation along, the slide rail. In one embodiment the slide rail may be substantially parallel to the beam and offset from the beam by the length of a plurality of insulators mounted between the beam and the slide rail.

The swing arm may include, in one embodiment: (a) a releasably lockable hinge coupler having a pivot linkage, wherein said hinge coupler is adapted for mounting to the free end of a crane or truck boom, and wherein in a normal operating orientation the boom may have a range of motion sweeping an angular orientation between substantially horizontal and substantially vertical; (b) an elongate, directionally reversible boom adapter arm having opposite first and second ends, wherein the first end of said boom adapter arm is pivotally mounted on the pivot linkage for releasably lockable pivoting about the pivot linkage relative to the hinge coupler, whereby said boom adapter arm is selectively orientable relative to said crane or truck boom between a downwardly oriented operational position relative to the boom, (c) a robotic arm jib, wherein the second end of the boom adapter arm is mounted to a first end of the robotic arm jib so as to collectively, with the boom adapter arm, form the swing arm. The opposite second end of the swing arm is coupled to the selectively positionable beam of the robotic arm. For example, the beam of the robotic arm may be pivotally coupled to the second end of the swing arm so that an actuator such as a hydraulic cylinder may be mounted between the beam and the swing arm to adjust the angular orientation of the beam.

In use, the beam may be positioned substantially horizontal so that the insulators extending downwardly from the beam are substantially vertical and so that wire cages on the lower ends of the insulators on the beam are used to pick and move the conductors from the distribution network poles to allow work by the manipulator arms on the tie wires on the pole's insulators. The wire cages may be remotely locked closed so as to secure their corresponding conductors, including by the use of a tool such as a wrench on the end of a robotic manipulator arm.

As stated above, the slide rail may, in one embodiment, be mounted to the beam, for example by using a plurality of electrical insulators therebetween, so that the slide rail is adjacent and parallel to the beam of the robotic arm. The length of the insulators between the slide rail and the beam is dictated by the voltage of the conductors, so that the slide rail and robotic manipulator are electrically insulated from the conductors suspended on the vertical insulators mounted to the beam of the robotic arm.

The robot may be slidably mounted on the slide rail so that it may be selectively, and for example sequentially, positioned along the slide rail to coincide with the position along the beam of each of the downwardly extending insulators mounted under the beam. In embodiments where the conductors are three phase, advantageously the beam has three insulators, one for each conductor. The selective translation of the robot along the slide rail is accomplished by a remotely operable drive in a mechanical translator mounted so as to cooperate between the robot and the slide rail. The drive may, for example, be a screw drive driven by an electric motor. Power for the mechanical translator may be supplied by a battery on the robot. The mechanical translator or a separate actuator may raise, lower, and rotate the robotic manipulator arms along and about a vertical axis, for example on and about a vertical shaft on which the at least one manipulator arm is mounted.

To position the beam and its downwardly extending insulators, the swing arm may be selectively oriented downwardly relative to a long axis of the boom so as to form an included angle between the boom and the boom swingarm in the range of 60-120 degrees. The swing arm may be at least substantially 12 feet long. The swing arm and the robotic arm advantageously lie substantially in a common plane so that the robotic arm is positionable by the actuator to rotate the beam of the robotic arm in the common plane.

In embodiments, the range of the included angle may be less than 60-120 degrees, for example 75-105 degrees, or for example substantially 90 degrees. The swing arm may be substantially linear or may curve downwardly so long as it will carry the loading on its free end due to the weight of the robotic arm, the conductors carried by the insulators on the robotic arm, and the robot.

### BRIEF DESCRIPTION OF THE DRAWINGS

The exemplary embodiments may be better understood, and numerous objects, features, and advantages made apparent to those skilled in the art by referencing the accompanying drawings. These drawings are used to illustrate only exemplary embodiments, and are not to be considered limiting of its scope, for the disclosure may admit to other equally effective exemplary embodiments. The figures are not necessarily to scale and certain features and certain views of the figures may be shown exaggerated in scale or in schematic in the interest of clarity and conciseness.

FIG. 1 illustrates a lineman approaching the limits of approach for a three phase 35 kV live conductor distribution network circuit on cross arm-mounted insulators.

FIGS. 2A-2O graphically illustrate a conventional insulator changing procedure performed by a lineman.

FIG. 3 illustrates a perspective view of an example of a robotic system for repairing or maintaining an electrical component connected to a conductor, consistent with disclosed embodiments.

FIG. 3A illustrates an enlarged view of the robotic manipulator arms of the example of a robotic system depicted in FIG. 3, consistent with disclosed embodiments.

FIG. 4 illustrates a front elevation view of the example of a robotic system of FIG. 3, consistent with disclosed embodiments.

FIG. 5 illustrates a perspective view of the example of a robotic system of FIG. 3 in a retracted configuration, consistent with disclosed embodiments.

FIG. 6 illustrates a front elevation view of the example of a robotic system of FIG. 5, consistent with disclosed embodiments.

FIG. 7 illustrates a plan view of the example of a robotic system of FIG. 5, consistent with disclosed embodiments.

FIG. 8 illustrates an enlarged view of the example of a robotic manipulator arms depicted in FIG. 5, having completed a repair or maintenance operation, consistent with disclosed embodiments.

FIG. 9 illustrates an enlarged view of the example of a robotic system of FIG. 6 performing a positioning operation, consistent with disclosed embodiments.

FIG. 10 illustrates a perspective view of the robotic manipulator arms of the example of a robotic system depicted in FIG. 8 about to perform a repair or maintenance operation, consistent with disclosed embodiments.

FIG. 11 illustrates a perspective view of the example of a robotic system of FIG. 3, consistent with disclosed embodiments.

FIG. 12 illustrates a front elevation view of the example of a robotic system of FIG. 11, consistent with disclosed embodiments.

FIG. 13 illustrates a side elevation view of the example of a robotic system of FIG. 11, consistent with disclosed embodiments.

FIG. 14 illustrates an enlarged view of an example of a boom adapter arm incorporated into the example robotic system depicted in FIG. 12, consistent with disclosed embodiments.

FIG. 15 illustrates a perspective view of an example of a crane or truck boom head adapter and boom adapter arm incorporated into the example robotic system depicted in FIG. 11, consistent with disclosed embodiments.

FIG. 16 illustrates a side elevation view, the example of a crane or truck boom head adapter and swing arm of FIG. 15, consistent with disclosed embodiments.

FIG. 17 illustrates a perspective view of the example of a crane or truck boom head adapter and swing arm of FIG. 15, consistent with disclosed embodiments.

FIG. 18 illustrates a side elevation view of the example of a swing arm and crane or truck boom head adapter depicted in FIG. 17, consistent with disclosed embodiments.

FIG. 19 illustrates the example swing arm and crane or truck boom head adapter depicted in FIG. 15 positioned in line with the main boom, consistent with disclosed embodiments.

FIG. 20 illustrates a side elevation view of the example swing arm and crane or truck boom head adapter of FIG. 19, consistent with disclosed embodiments.

FIG. 21 illustrates a perspective view of an example of a hinge coupling of the example crane or truck boom head adapter depicted in FIG. 15, consistent with disclosed embodiments.

FIG. 22 illustrates a perspective view of the example of a boom adapter arm depicted in FIG. 15, consistent with disclosed embodiments.

FIG. 23 illustrates a perspective view of the example of a boom adapter arm and hinge coupler depicted in FIG. 5 rotated back 15 degrees, consistent with disclosed embodiments.

FIG. 24 illustrates a side elevation view of example of a boom adapter arm and hinge coupler depicted in FIG. 23, consistent with disclosed embodiments.

FIG. 25 illustrates a perspective view of the example of a boom adapter arm and hinge coupler depicted in FIG. 17, consistent with disclosed embodiments.

FIG. 26 illustrates a side elevation view of the example of a boom adapter arm and hinge coupler depicted in FIG. 25, consistent with disclosed embodiments.

FIG. 27 illustrates a perspective view of an example of a boom adapter arm positioned 90 degrees to the truck or crane boom, consistent with disclosed embodiments.

FIG. 28 illustrates a side elevation view of the example of a boom adapter arm depicted in FIG. 27, consistent with disclosed embodiments.

FIGS. 29A-29L graphically illustrate front elevation views of an insulator changing procedure performed by the example of a robotic system of FIG. 3, consistent with disclosed embodiments.

FIG. 29M illustrates the diagrammatic commencing of the insulator changing procedure of FIGS. 29A-29L when the beam is vertically oriented and the insulators are horizontally oriented, consistent with disclosed embodiments.

FIG. 30 illustrates a side elevation view of an example of an insulator with a clamp at its upper end to hold the conductor on the insulator, consistent with disclosed embodiments.

FIG. 31 illustrates an enlarged perspective view of an example of a wire cage, consistent with disclosed embodiments.

FIG. 32 illustrates a side elevation view of the example of a wire cage of FIG. 31, consistent with disclosed embodiments.

FIG. 33 illustrates a perspective view of another example of a robotic system for repairing or maintaining an electrical component connected to a conductor, the system having three robots, consistent with disclosed embodiments.

FIG. 34 illustrates a perspective view of another example of a robotic system for repairing or maintaining an electrical component connected to a conductor, the system having a single robot mounted on a single pick, consistent with disclosed embodiments.

FIG. 35 illustrates an enlarged view of the example of a robotic system of FIG. 34, consistent with disclosed embodiments.

FIG. 36 illustrates a perspective view of an exemplary seven-degree-of-freedom single robotic manipulator arm, consistent with disclosed embodiments.

FIG. 37 illustrates a left side perspective view of the example of a robotic manipulator arm depicted in FIG. 36, consistent with disclosed embodiments.

FIG. 38 illustrates a right side perspective view of the example of a robotic manipulator arm depicted in FIG. 37, consistent with disclosed embodiments.

FIG. 39 illustrates a front elevation view of an example of a robotic manipulator arm mounted on a slide rail and having an end effector, consistent with disclosed embodiments.

FIG. 40 illustrates a perspective view of the example of a robotic manipulator arm and slide rail depicted in FIG. 39, consistent with disclosed embodiments.

FIG. 41 illustrates an enlarged view of an example of an end effector of the example of a robotic manipulator arm depicted in FIG. 39, consistent with disclosed embodiments.

FIG. 42 illustrates a perspective view of the example of an end effector as depicted in FIG. 41, consistent with disclosed embodiments.

Similar reference numerals may refer to similar parts throughout the several views of the drawings unless otherwise clearly represented.

### DETAILED DESCRIPTION

The following disclosure provides many different examples of embodiments, including examples of apparatuses, methods, techniques, and instruction sequences, for implementing different features of the provided subject matter. Specific simplified examples of components and arrangements are described below to explain the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The terms used in this specification generally have their ordinary meanings in the art and in the specific context where each term is used unless otherwise explicitly defined. The use of examples in this specification, including examples of any terms discussed herein, is illustrative only, and in no way limits the scope and meaning of the disclosure or of any exemplified term. Likewise, the present disclosure is not limited to various embodiments given in this specification.

Conventional methods for changing insulators on electric poles typically involve a series of manual steps, specialized equipment, and adherence to strict safety protocols. These methods often require significant time and labor, posing challenges in terms of efficiency and cost-effectiveness. Additionally, the complexity of the process and the inherent risks associated with working at height in the presence of energized conductors present potentially unsafe situations for linemen.

Despite advancements in electric pole maintenance techniques, there remains a need for improved methods and apparatuses for changing insulators that can streamline the process, enhance lineman safety, and optimize resource utilization.

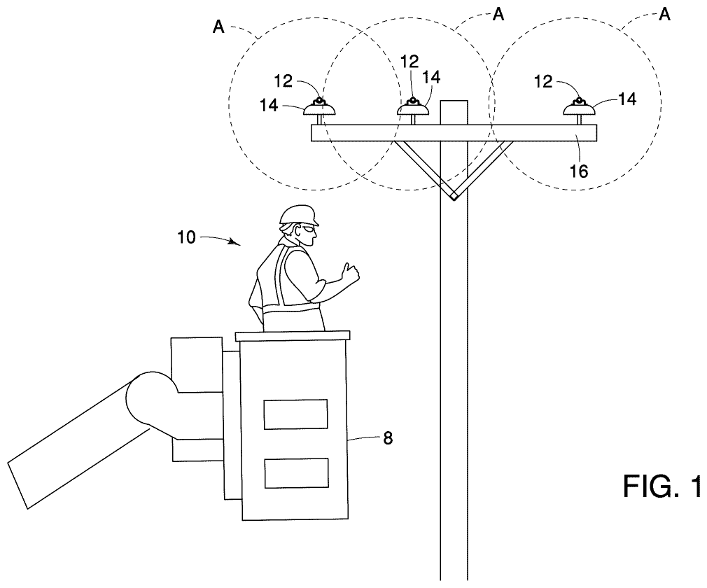

FIG. 1 diagrammatically illustrates the close confines of a lineman 10 being elevated in a bucket 8 so as to work on a typical three phase arrangement of 35 kV conductors 12. Conductors 12 may include energized lines supported on corresponding insulators 14 on pole cross arm 16. Limits of approach A, indicated by circles of dotted lines, may easily be inadvertently crossed by lineman 10 reaching in to accomplish a repair or maintenance operation, in so doing coming within the limits of approach A for the conductors 12. Limits of approach A may define a minimum safe distance that a person, tool, or equipment should maintain from an energized power line (e.g., conductors 12) to prevent electrical hazard such as shock or arc flash. Indeed, in some examples and as depicted in FIG. 1, the limits of approach A may overlap, which may greatly increase the risk that lineman 10 may come within limits of approach A.

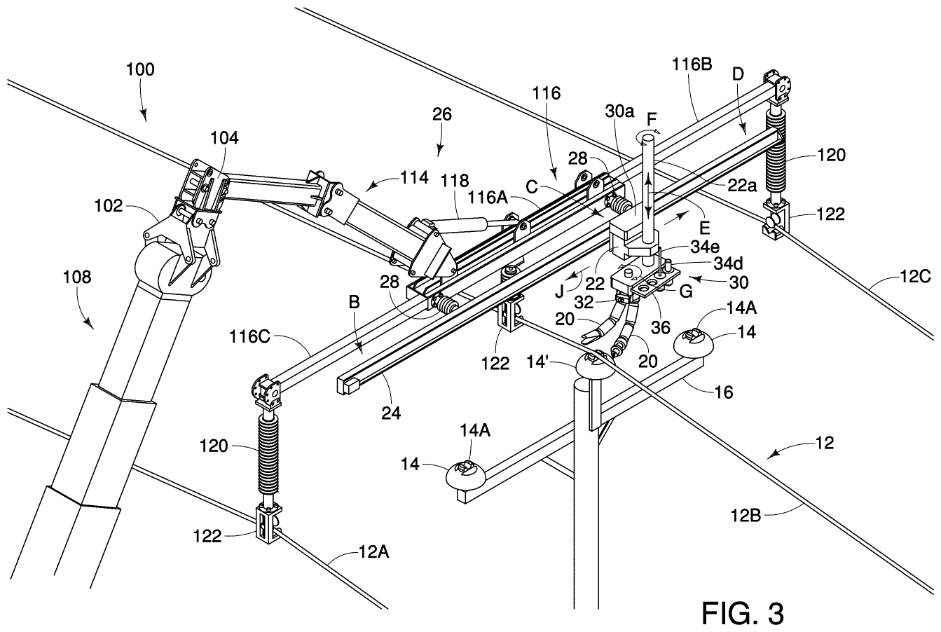

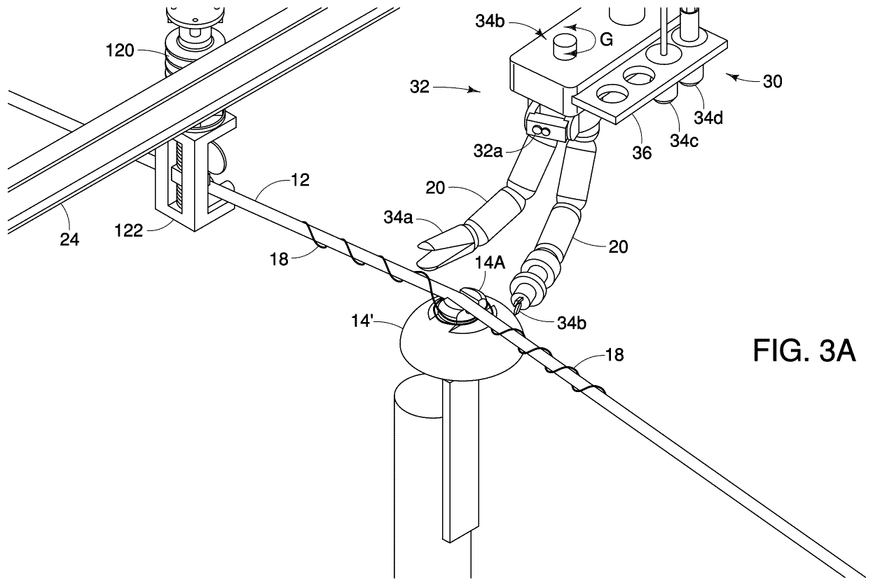

One example of a repair or maintenance operation performed by lineman 10 may include tying tie wires (e.g., tie wires 18 in FIG. 3A) to mount a conductor 12 onto its insulator 14. Without intending to be limiting and with reference to FIG. 3A, one example of a method of tying tie wires 18 may include, when conductor 12 is seated on its insulator 14, securing conductor 12 onto its insulator 14 by wrapping a length of tie wire 18 (e.g., a middle portion) firstly around the top of insulator 14 in an annular groove on insulator 14 designed for that purpose. The method further includes wrapping each of the opposite ends of the length of tie wire 18 (e.g., a first end and a second end) in a spiral around conductor 12 so as to be immediately adjacent and on either side of the insulator 14. Conventionally, this task is done by lineman 10 working from a bucket on a bucket truck. Again, because of the overlapping limits of approach A for a 35 kV line, the lineman may violate those limits of approach A while tying the tie wires for at least one of the three phases. The example herein employing 35 kV conductors is merely intended to give one example of a common task required of a lineman working on a distribution network. It is not intended to be limiting as other tasks, including other tasks on other voltage networks, such as high voltage transmission networks associated with correspondingly larger limits of approach, are intended to fall within the ambit of this disclosure.

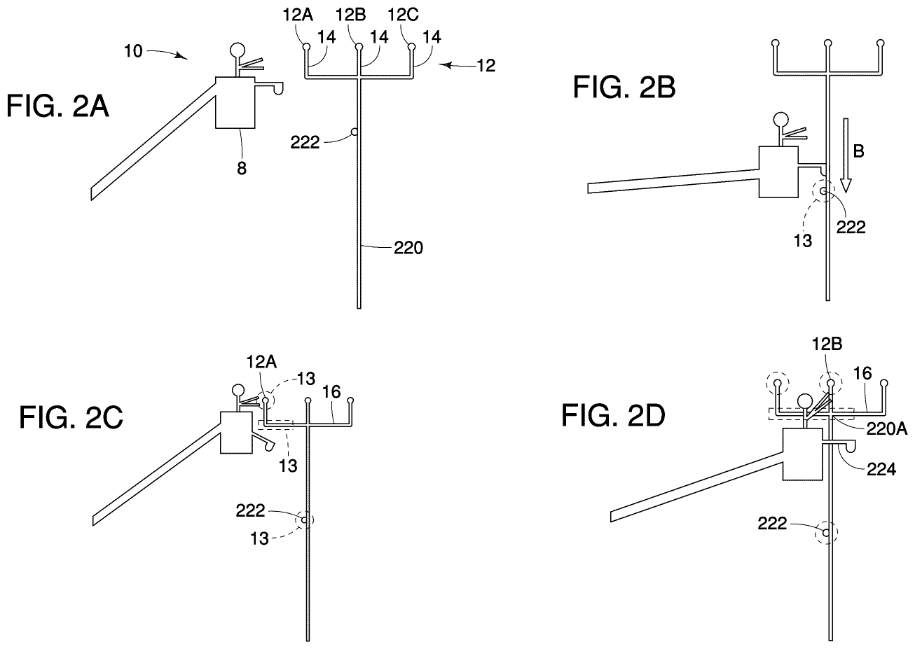

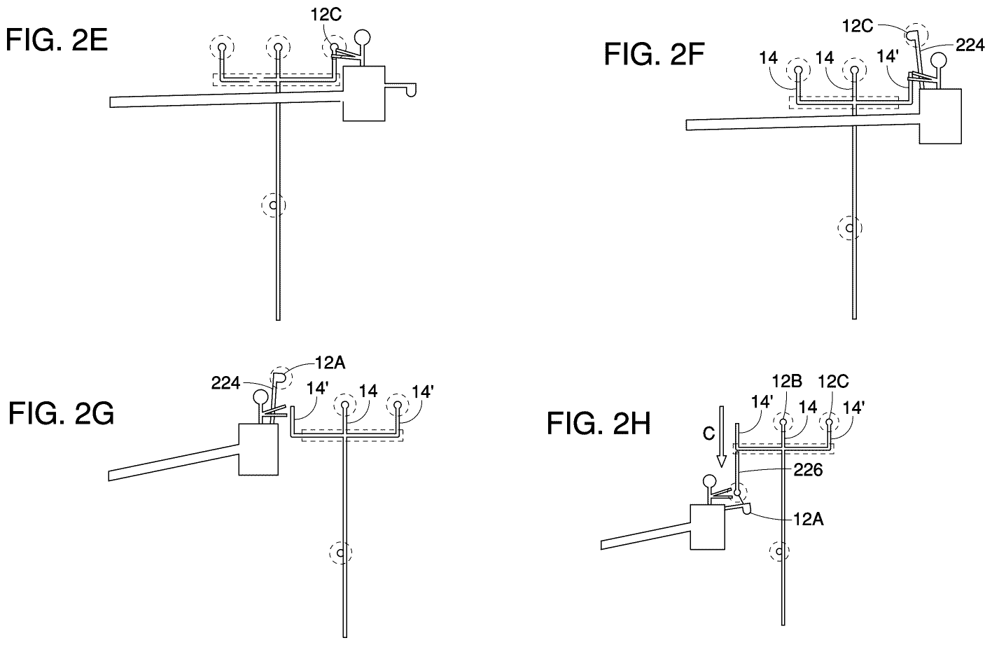

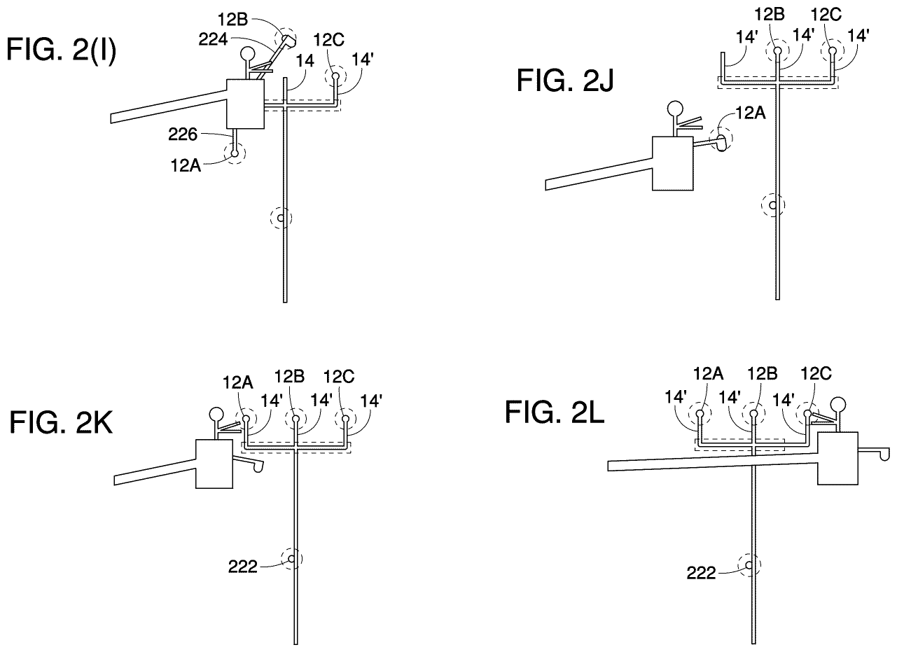

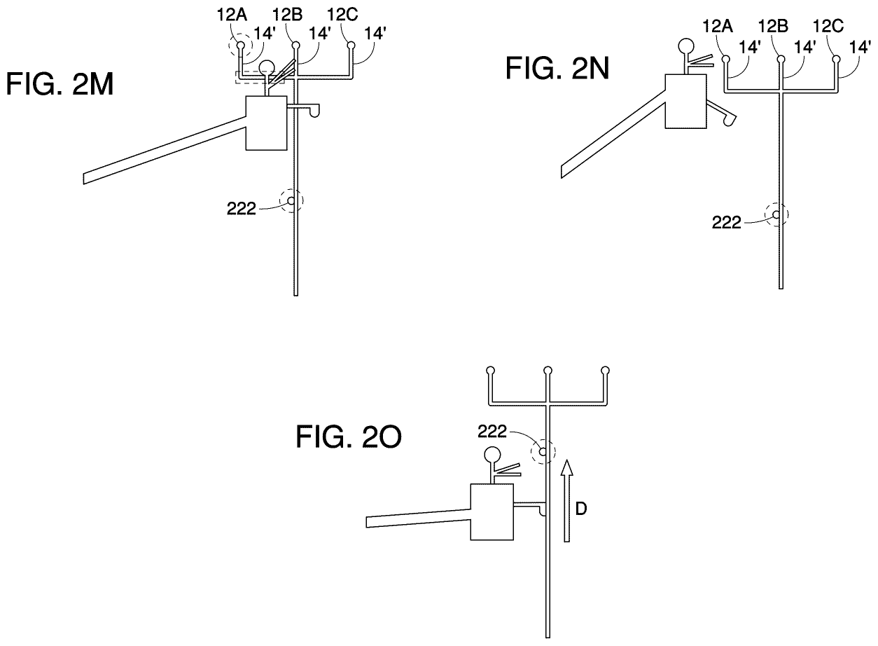

By way of another example not intending to be limiting, one task that is routinely done by the lineman is changing an insulator. One conventional method is graphically illustrated in FIGS. 2A through 2O as a series of sequential steps taken by a lineman to change an insulator.

First, as depicted in FIG. 2A, lineman 10 in bucket 8 may approach pole 220. Then as depicted in FIG. 2B, lineman 10 may secure neutral wire 222 by covering it with an electrically insulated cover 13 and moving neutral wire 222 downward in direction B, thereby ensuring neutral wire 222 is firmly secured to the lower section of pole 220. As used herein, an insulated cover 13 may be one of several insulated covers 13 shown in the various views in FIGS. 2A-2O (e.g., as depicted as separate shapes having a dotted outline) and may include any suitable insulated cover known to those skilled in the art. As depicted in FIGS. 2B-2O, insulated covers 13 may be represented by a dotted outline.

Then as depicted in FIG. 2C, lineman 10 may cover road phase 12A and cross arm 16 with insulated covers 13. Then as depicted in FIG. 2D, lineman 10 may cover center phase 12B, cross arm 16, and pole top 220A with insulated covers 13. Then as depicted in FIG. 2E, lineman 10 may cover field phase 12C and cross arm 16 with insulated covers 13.

Then as depicted in FIG. 2F, the field phase 12C may be picked using a jib 224 mounted on bucket 8 and moved to a clear location (e.g., a safe distance away from pole 220), the insulator-to-be-changed 14 (i.e., the original insulator) may be changed for a new, replacement insulator 14′, and the field phase 12C may be reinstalled onto the new insulator 14′. A similar process may be repeated for road phase 12A (e.g., as depicted in FIG. 2G). As depicted in FIG. 2H, to access the center phase 12B, a temporary link stick 226 may be installed under the position of road phase 12A so as to depend downwardly from cross arm 16. The road phase 12A may then be moved and held in the lowermost end of the temporary link stick 226 for the duration of the insulator change on center phase 12B. Then as depicted in FIG. 2I, a similar process as depicted in FIGS. 2G and 2H may be repeated for center phase 12B.

As depicted in FIG. 2J, once the center phase 12B change is complete, the road phase 12A may be picked on jib 224 and temporary link stick 226 may be removed. Then as depicted in FIG. 2K, road phase 12A may be reinstalled onto its new insulator 14′. Then as depicted in FIG. 2L, lineman 10 may remove insulated covers 13 from field phase 12C and the adjacent end of cross arm 16. Then as depicted in FIG. 2M, lineman 10 may remove insulated covers 13 from center phase 12B and the adjacent center section of cross arm 16. Then as depicted in FIG. 2N, lineman 10 may remove insulated covers 13 from road phase 12A and the adjacent end of cross arm 16. Lastly and as depicted in FIG. 2O, the neutral wire 222 may be elevated back to its original position, completing the insulator change process.

However, this conventional manual method of changing insulators by the linemen suffers from various disadvantages. Firstly, minimal operating clearances to remove the jib can pose significant challenges, especially when working in close proximity to energized lines. Traditionally, linemen face limitations in maneuverability and safety due to the confined space. Additionally, the need to maintain distance from different potentials complicates the relocation of conductors to perform necessary work, often requiring multiple movements and adjustments.

Secondly, tight clearances on poles with underbuilt utilities present another obstacle for conventional manual methods. Linemen typically operate within a confined workspace, at an elevation between their hips and shoulders while standing in a bucket. This restricted space not only hampers maneuverability but also creates the risk of encroaching on underbuilt utilities, leading to potential damage or safety hazards.

Therefore, the issue of lineman exposure to energized lines and tight clearances between phases and ground presents a significant challenge in ensuring worker safety during electrical maintenance and construction activities. To address this challenge, current practices involve the use of insulated cover-ups (e.g., insulated covers 13) along with the temporary relocation of phases. While this approach may help create space for linemen, it often results in ground clearance issues as conductors are shifted to lower locations. This not only adds complexity to the task but also increases the risk of accidental contact with the ground.

Furthermore, working from below conductors introduces additional hurdles in achieving adequate physical clearances for equipment installation, posing potential safety hazards for workers. Despite the availability of ample space above, utilizing it is not always feasible or ergonomically suitable for human work, thus highlighting the need for alternative solutions. Additionally, conducting operations, such as pole changeouts, in environments with limited right-of-way or roadside space requires careful coordination of multiple trucks, which further complicates the logistical aspects of the project and may lead to delays or inefficiencies if not managed effectively.

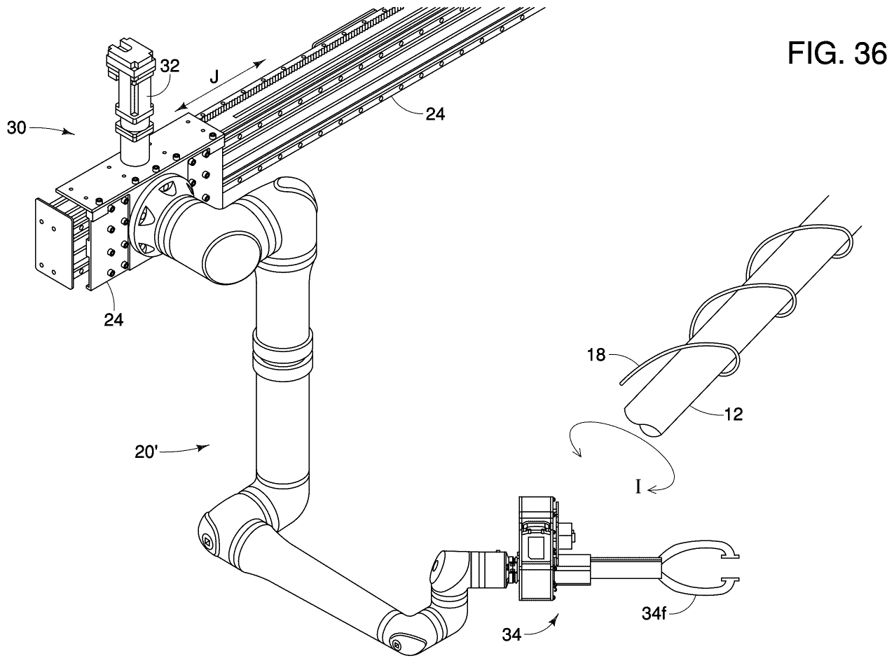

In an example of an illustration of a proposed solution to the above-identified problems, FIGS. 3 and 3A illustrate how a pair of articulated robotic manipulator arms 20 mounted on, so as to articulate from a robot 30, may be employed to perform a maintenance or repair operation on an electrical component connected to a conductor. For example, the maintenance or repair operation may include wrapping tie wire 18 around the top of an insulator 14 and in a spiral around the adjacent lengths of the conductor 12. As depicted in FIG. 3, when conductor 12 has been lifted away from insulators 14 and the old insulator 14 replaced with a new insulator 14′, the robotic manipulator arms 20 may be articulated (e.g., remotely by a remotely located operator, by a pre-programmed or artificially intelligent computer processor) to bring a short length of tie wire 18 to the top of the new insulator 14′. The robotic manipulator arms 20 may then manipulate tie wire 18 so as to wrap it around the top of new insulator 14′, leaving a length of tie wire 18 extending from opposite sides of new insulator 14′. Once conductor 12 has then been positioned back onto the saddle 14A of new insulator 14′, the robotic manipulator arms 20 may be articulated (e.g., remotely by a remote operator, by a pre-programmed or artificially intelligent computer processor) to wrap ends of the tie wire 18 in a spiral around the adjacent lengths of conductor 12 on opposite sides of new insulator 14′, thereby mimicking the tying of the tie wire 18 as would have been conventionally done by the lineman 10. A diagrammatic representation and corresponding description of using a robotic manipulator arm 20 to spiral tie a tie wire onto a conductor is further described below with respect to FIGS. 36 and 36A.

The procedure of tying of tie wire 18 described above with respect to FIGS. 3 and 3A may be similarly repeated for each of the three phases of conductors 12. After completing the procedure for one set of conductors 12, robotic manipulator arms 20 may be moved to another of the set of insulators 14 (not depicted) such as on the next adjacent pole having at least one insulator 14 in need of replacement or maintenance, and the process repeated, and so on until all of the insulators 14 needing replacement have been replaced with new insulators 14′. In this way, robotic manipulator arms 20 removes lineman 10 from possibly having to encroach into the limits of approach A in order to perform a repair or maintenance operation, such as tying tie wires 18 for a conductor 12. In some embodiments, the pair of robotic manipulator arms 20 may be manipulated remotely by an operator to accomplish a repair or maintenance operation. Additionally or alternatively, in some embodiments, robotic manipulator arms 20 may utilize an autonomous or semi-autonomous processing system including sufficient sensors, software, and processing power, as would be known to one skilled in the art, to accomplish a repair or maintenance operation. For example, the repair or maintenance operation may include a repetitive task such as initially picking the conductors 12 from the old insulators 14, positioning one or more robotic manipulator arms 20 in preparation for changing the insulators 14 to new insulators 14′, and securing the corresponding conductor 12 back onto the new insulator 14′ with tie wires 18.

FIGS. 3 and 3A provide one example of how robotic manipulator arms 20 may be used to untie and then re-tie tie wires 18 for the three insulators 14 supporting the three phases of conductors 12. In some embodiments, robot 30 may comprise one or more robotic manipulator arms 20. In one embodiment, robot 30 may comprise one robotic manipulator arm 20. In another embodiment, robot 30 may comprise a plurality of robotic manipulator arms 20. In general, it may be understood that robot 30 may include any suitable number of robotic manipulator arms 20 to perform a repair or maintenance operation.

In some embodiments, robot 30 may be mounted on a carriage 22 so as to move the robotic manipulator arms 20 from one insulator location to another on cross arm 16. As depicted in FIG. 3, to accomplish moving carriage 22, the carriage 22 is slidably mounted on a slide rail 24 so that the robot 30 and its robotic manipulator arms 20 may be selectively positioned, e.g., generally at locations B, C, and D corresponding respectively to the location of each of the three insulators 14 on cross arm 16. In some embodiments, slide rail 24 may be linear. In other embodiments, slide rail 24 may be non-linear. For example, slide rail 24 may be bowed or otherwise curved. In general, it may be understood that slide rail 24 may have any suitable shape or configuration to facilitate a positioning of a slidably-mounted component (e.g., robot 30 and its robotic manipulator arms 20).

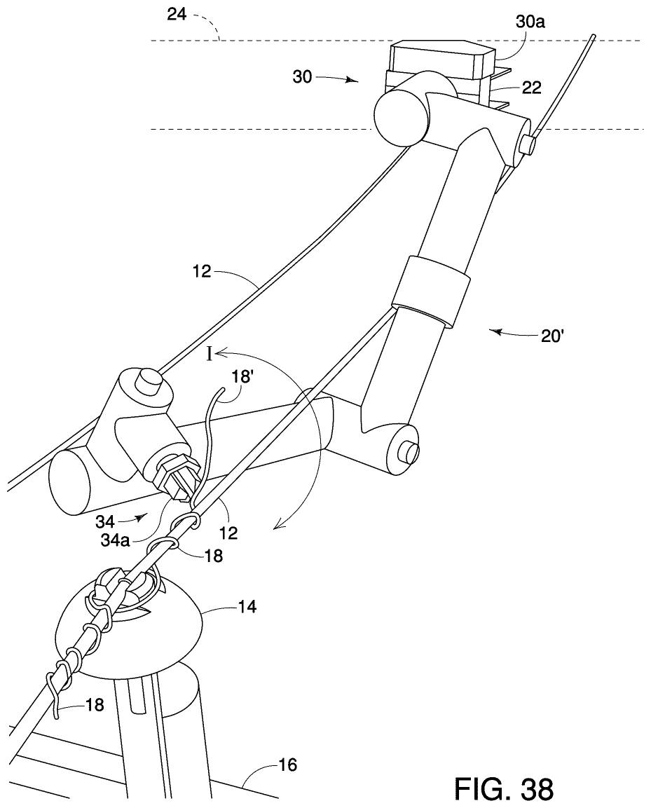

In some embodiments, robot 30 may be slidably mounted on slide rail 24 so that it may be selectively, and for example sequentially, positioned along slide rail 24 to coincide with the position along beam 116 of a robotic arm of each of the three downwardly extending insulators 120. The selective translation of robot 30 along slide rail 24 may be accomplished by a remotely-operable drive in a mechanical translator mounted so as to cooperate between the robotic manipulator and the slide rail. The drive may, for example, be a screw drive driven by an electric motor (not shown). Power for the mechanical translator may be supplied by a battery 30a seen, for example, mounted above carriage 22 in FIGS. 3 and 38. The mechanical translator may also raise, lower, and rotate the robotic manipulator arms about along and about a vertical axis, for example on and about a vertical shaft 22a.

In some embodiments, slide rail 24 may be mounted on electrical insulators 28 so as to be electrically insulated from beam 116 of a robotic arm in boom-mounted support structure 26. By way of non-limiting example, the robotic arm may be an inverted LineMaster™ robotic arm suspended from swing arm 114. In such an example, the boom-mounted support structure 26 may support slide rail 24 so that it is substantially parallel to beam 116 and spaced from beam 116 by the length of insulators 28. In some embodiments, the length of insulators 28 will be at least the length dictated by the voltage of conductors 12 if conductors 12 are live or are to be treated as live due to the possibility of induced voltage or a ground recirculating current.

As depicted in FIG. 3, for a high distribution voltage (e.g., 35 kV), insulators 28 may not be very long. Thus, FIG. 3 depicts using two insulators 28 to support the weight of robot 30, including robotic manipulator arms 20, carriage 22, slide rail 24, battery 30a and the mechanical translator. However, in other examples, a different number of insulators 28 may be used to suitably distance and provide electrical insulation between slide rail 24 and beam 116. Again, the mechanical translator may be configured to selectively translate robot 30 and its associated components in one or more axes and may operate as would be known to one skilled in the art. Those associated components may vary depending on the application, complexity of task, level of autonomy, etc. By way of non-limiting example, the associated components may include one or more of: a frame, a power supply, one or more motors (e.g., electric motors including stepper motors), a transmission, one or more actuators, one or more end-effectors, at least one processor, a sensor package comprising one or more sensors (e.g., perception and feedback sensors, optical cameras in stereo vision or otherwise, laser triangulation sensors and other non-contact sensors, contact sensors such as stress and strain sensors), links, joints, or hydraulics. In general, it may be understood that any combination of the foregoing components, including combinations in which not all of the components are included in a same embodiments, are contemplated within the scope of this disclosure. Further, these components are not intended to be limiting, as robotic technology is constantly evolving so as to be lighter and have greater mobility, speed, agility, and independence. Additionally, robotic technology is evolving to incorporate machine learning or artificial intelligence, all of which would be, or will become, known to one skilled in the art of robotics.

### Robotic Manipulator System

In some embodiments, a robotic system 100 may include one or more of a sensor package 32, a robot 30, a mechanical translator, or at least one insulator. Robot 30 may comprise one or more robotic manipulator arms 20 pivotally connected to the robot and a logic unit (not shown).

In some embodiments, sensor package 32 may include one or more of: a camera, a proximity sensor, a laser sensor, a Global Positioning System (GPS) sensor, a gyroscope sensor, an inertial measurement unit (IMU) sensor, or an accelerometer. By way of non-limiting example, one or more cameras or proximity sensors 32a (e.g., a laser sensor, a LiDAR (light detection and ranging) sensor, or an ultrasonic sensor) may be configured to detect a location of electrical components (e.g., insulators 14, conductors 12, cross arm 16, or tie wire 18) or an obstacle which may impede robot 30 from performing its task (e.g., repair or maintenance operation). An obstacle may include a tree, a tree branch, ice or snow buildup, wildlife (e.g., bird, rodent, or any other animal), a kite, a balloon, overgrown vegetation (e.g., shrub or vine growing near or on the conductor), or any other environmental feature that may impede robot 30.

In some embodiments, sensor package 32 may be configured to sense and process the at least one parameter. For example, sensor package 32 may be configured to sense and to determine the at least one parameter associated with an electrical component and/or robot 30 based one or more of the following sensed data: an infrared image, a radar scan, an ultrasonic signal, or a laser-triangulated position of an obstacle or electrical component. In some embodiments, sensor package 32 may be configured to provide visual feedback to a remote operator. For example, sensor package may be rotationally mounted for bi-directional motion in direction G on rotational actuator 32b so that the sensors may be steered by the operator or logic unit independent of the motion of robotic manipulator arms 20, robot 30, or carriage 22. In some embodiments, sensor package 32 may transmit sensed data to a display associated with an operator. For example, sensor package 32 may transmit (e.g., wirelessly, via a wired connection) visual data (e.g., image, video) to a processor configured to display the visual data on a display associated with an operator (e.g., a mobile device, a tablet, a computer, any other suitable display screen). Additionally or alternatively, sensor package 32 may transmit sensed location data to a processor configured to process and display the sensed location data to generate a representation of the environment around robot 30.

In some embodiments, sensor package 32 may be configured to sense at least one parameter associated with robot 30. For example, sensor package 32 may be integrated with robot 30 and configured to sense one or more of: a location of robot 30 and its associated components (e.g., robotic manipulator arms 20, end effectors 34), a distance from an electrical component, a relative velocity (including the velocity vectors) of robot 30 and its associated components, an acceleration of robot 30 and its associated components, or an orientation of robot 30 and its associated components.

In some embodiments, robot 30 may include a logic unit. A logic unit may include any type of processing device, including, for example, a computer, a microprocessor, a single or multi-core processor, microcontroller, central processing unit, or any circuitry that performs logic operations.

In some embodiments, a logic unit may be configured to control one or more robotic manipulator arms to perform a repair or maintenance operation. In one example, a logic unit of robot 30 may be configured to control robotic manipulator arms 20 to release an electrical component (e.g., insulator 14) from a conductor 12 (e.g., untie a tie wire or unclamp the electrical component) based on at least one sensed parameter received from sensor package 32 or commands received from an operator. Additionally or alternatively, a logic unit of robot 30 may be configured to control robotic manipulator arms 20 to replace an electrical component (e.g., insulator 14) with a new electrical component (e.g., new insulator 14′) based on at least one sensed parameter received from sensor package 32 or commands received from an operator. Additionally or alternatively, a logic unit of robot 30 may be configured to control robotic manipulator arms 20 to secure an electrical component (e.g., new insulator 14′) to a conductor 12 (e.g., tie a tie wire or clamp the electrical component) based on at least one sensed parameter received from sensor package 32 or commands received from an operator.

In some embodiments, robot 30 may include one or more robotic manipulator arms 20. In some embodiments, robotic manipulator arms 20 may include interchangeable end effectors 34 operably coupled on the ends of robotic manipulator arms 20. The end effectors 34 may be configured to handle, pull, manipulate, spiral, or cut to length tie wires 18. By way of non-limiting example, end effector 34 may include one or more of: the grippers 34a and the snippers 34b shown in FIG. 3A, the claw 34f shown in FIG. 36, or the saw blade 34c shown in FIG. 41. Other non-limiting examples of end-effectors 34 may include a hand tool 34d (e.g., a wrench, pliers, or a screwdriver) or a bond-on wand 34e for bonding on the robotic manipulator arms 20 onto a conductor 12. A further non-limiting example of an end effector 34 may include a precise heat source (not shown) to melt through the tie wire located adjacent the insulator body.

In some embodiments, a mechanical translator may be configured to position robot 30 along slide rail 24. A mechanical translator may include an actuator or device that selectively moves a component based on a received input. For example, a mechanical translator may include a carriage 22 and vertical (direction E) and rotational (direction F) actuators operating on vertical shaft 22a and operatively coupled to robot 30 for selectively moving, so as to position, robot 30 and robotic manipulator arms 20 into cooperative engagement with a target electrical component (e.g., insulator to be replaced).

In some embodiments, at least one insulator 120 may include a wire cage 122 at one end. Wire cage 122 may be configured to releasably hold a conductor (e.g., a live conductor). Insulator 120 may be connected to beam 116 at another end. In some embodiments, insulator 120 may be configured to electrically insulate beam 116 from a conductor. For example, when a live conductor 12 is held in wire cage 122, insulator 120 may prevent a charging current from conductor 12 from reaching beam 116. In some embodiments, at least one insulator 120 may be connected to beam 116 so as to be positioned downwardly relative to beam 116.

In some embodiments, robotic system 100 may be at least partially encased in Faraday shields. For example, all or part of robotic system 100 may be encased in Faraday shields of appropriate construction (e.g., rigid; flexible, including bond-on fabric used in lineman bond-on suits; rubber) to protect at least part of robotic system 100 (e.g., the electronics, including the logic unit). The use of Faraday shields protects the electronics during deliberate or inadvertent (e.g., accidental contact) electrical bond on to the conductors 12. In some embodiments, a combination of one or more Faraday shields may be employed. For example, flexible fabric Faraday shielding may encase components that flex, such as robotic manipulator arms 20, and rigid Faraday shielding may encase rigid components, such as the body of robot 30. In some embodiments, at least part of robot 30 or robotic manipulator arms 20 may comprise a high density highly dielectric composite. For example, robotic manipulators arms 20 and end effectors 34 may comprise fiberglass-reinforced polymer (FRP), epoxy-glass composites (e.g., G10/G11), silicone rubber composites, or any other suitable high density, highly dielectric composite. The sensor package 32 may include sensors configured to detect changes in electromagnetic field due to the presence of electrical components.

In some embodiments, robotic system 100 may include a dispensing mechanism. A dispensing mechanism may include a device for dispensing lengths of tie wire 18 or discreet individual pre-cut tie wires 18, to provide a convenient and continuous supply of tie wires for installation. For example, robotic system 100 may include a dispensing mechanism (not shown) attached to robot 30 or carriage 22. Logic unit of robot 30 may be configured to govern the operation of one or more components of robotic system 100, including, for example: determining the position of the robotic manipulator arms 20 based on at least one sensed parameter by sensor package 32 (e.g., in relation to the electrical components, such as insulators 14 and conductors 12); the position and operation of the tie wire dispenser; the manipulation sequencing for tie wire removal or installation; and the overall coordination of the movement and positioning of robot 30, including carriage 22 and robotic manipulator arms 20 on the beam 116 or on the slide rail 24 mounted to beam 116.

In some embodiments, robotic system 100 may include a slide rail mounted to beam 116, the translation mechanism system, or mechanical translator. For example, robotic system 100 may include slide rail 24 connected to and electrically insulated from beam 116. Further, carriage 22 and robot 30 may be slidably mounted on slide rail 24 such that robot 30 may move from one electrical component location, such as one insulator 14, to another.

Operation of Robot: Position of Robot in Alignment with the Insulator

In some embodiments, once the robot manipulator system 100 is powered on, the computer or logic unit initializes the system. For example, once robotic system 100 receives power from a power source (e.g., a battery on robot 30, a battery or generator located in the truck or crane and electrically connected to robot 30), a logic unit of robot 30 may be configured to system perform one or more self-checks to verify the functionality of connected components, including robotic manipulator arms 20, sensor package 32, and a tie wire dispenser. The one or more self-checks may include specific calibration routines that are executed to ensure precise alignment and accuracy of the robotic manipulator arms 20 and sensor package 32.

### Path Planning and Navigation

In some embodiments, robotic system 100 may be configured to activate its electrical insulator detection system. The electrical insulator detection system may comprise sensors such as cameras, lidars, or other proximity sensors (e.g., sensor package 32). The sensors may scan the environment and may identify locations of insulators 14 along the installation path (e.g., along conductor 12). A logic unit of robot 30 may process data received from the sensors to create a map of the insulator positions and their respective coordinates. In some embodiments, the logic unit may be configured to generate one or more path plan for robot 30 and robotic manipulator arms 20 to traverse. For example, the logic unit may determine the one or more path plans for robot 30 based at least in part on at least one parameter sensed by sensor package 32. Further, the logic unit may be configured to determine the path plan while considering factors such as obstacle avoidance (e.g., cross arms 16, energized conductors 12), shortest path, and optimization of arm movements to minimize travel time. As the robotic manipulator arms 20 approach the location of an insulator 14 along the planned path (e.g., as moved by a mechanical translator), the logic unit may instruct the robotic manipulator arms 20 to adjust their positions (e.g., spatial orientation), velocity (e.g., increase, decrease), and acceleration (e.g., increase or decrease) for optimal access, which includes the consideration of factors. In some embodiments, visual feedback from sensor package 32 may be transmitted for display to an operator and may aid in precise positioning of end effectors 34 relative to the insulator 14.

### Closing the Wire Holders on the Robotic Arm Insulators

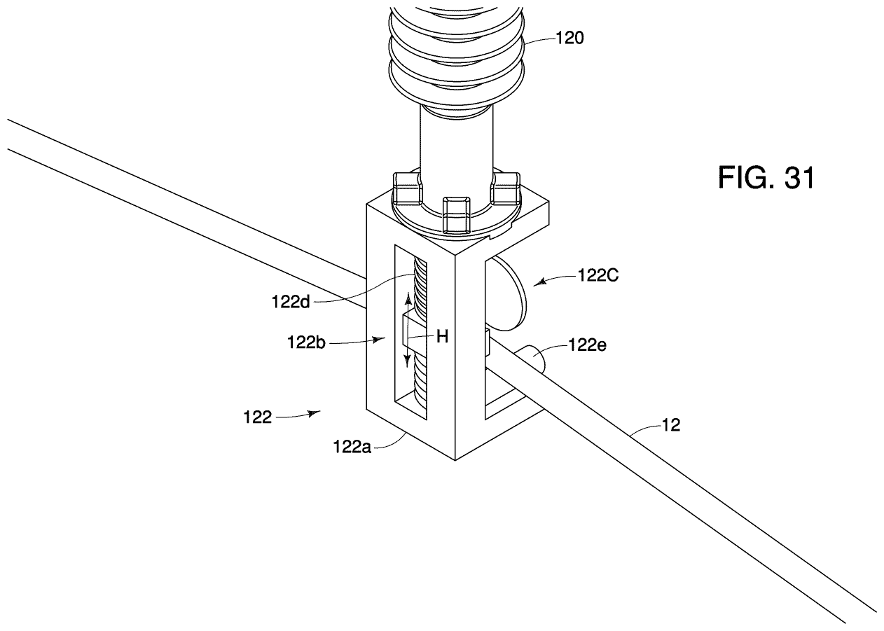

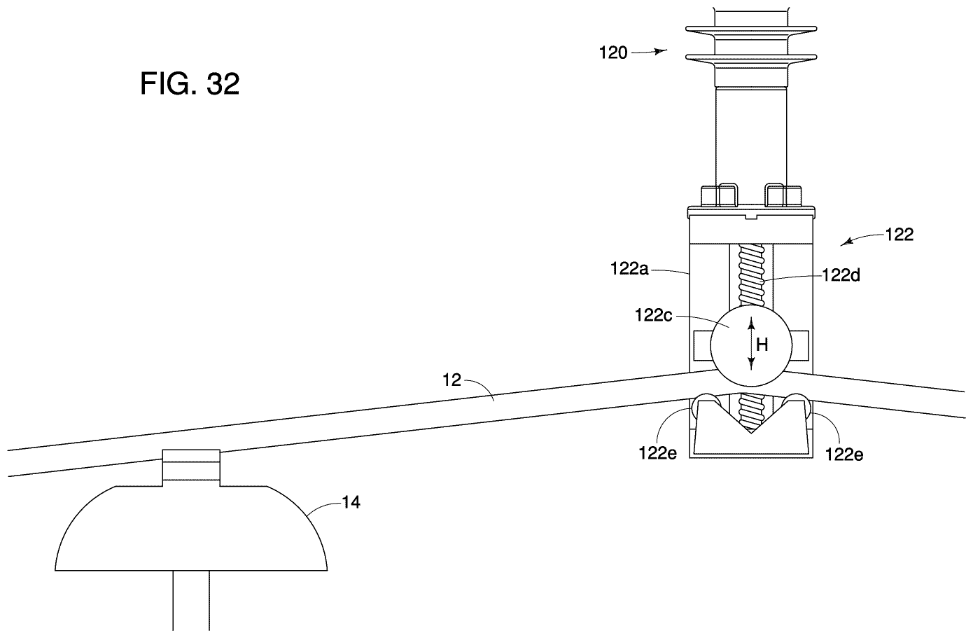

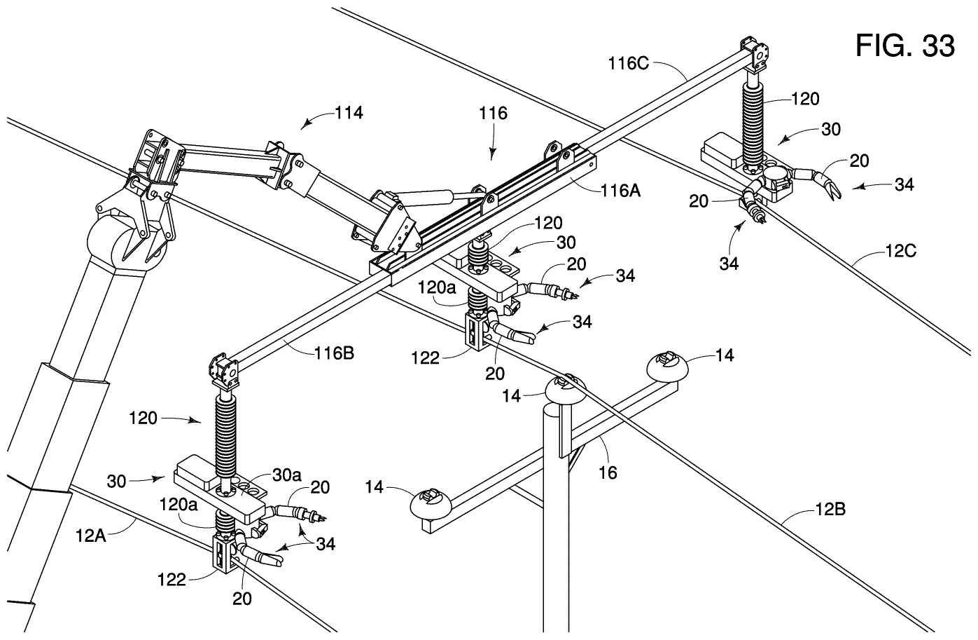

In some embodiments, sensor package 32 may be configured to identify the positions of wire holders, otherwise referred to as conductor holders or wire cages, mounted on the lower ends of insulators extending downwardly from the beam of the robotic arm. Upon detecting a conductor holder, logic unit may instruct the robotic manipulator arms 20 to maneuver to position end effectors 34 near the conductor holder. End effectors 34 may include socket wrench tool 20d, which may be mounted on the end of a robotic manipulator arm 20. Further, socket wrench tool 20d may be used to operate, for example, a screwdriver as depicted in FIGS. 31 and 32, to open or close a clamp clamping down onto the conductor 12 held in the conductor holder. In some embodiments, sensor package 32 may include force sensors (not shown) configured to sense a torque applied by socket wrench tool 20d. For example, the force sensors may sense and transmit a sensed torque applied by socket wrench tool 20d to a logic unit or computer of robot 30. The logic unit may be configured to ensure that adequate torque is applied by socket wrench tool 30d to the exposed nut on the drive of the screw drive to ensure the clamp is fully closed down onto conductor 12 so as to securely retain conductor 12. In some embodiments, camera sensors may be used to provide visual data (e.g., transmitted for display to an operator) for checking whether conductor 12 is secure in the conductor holder.

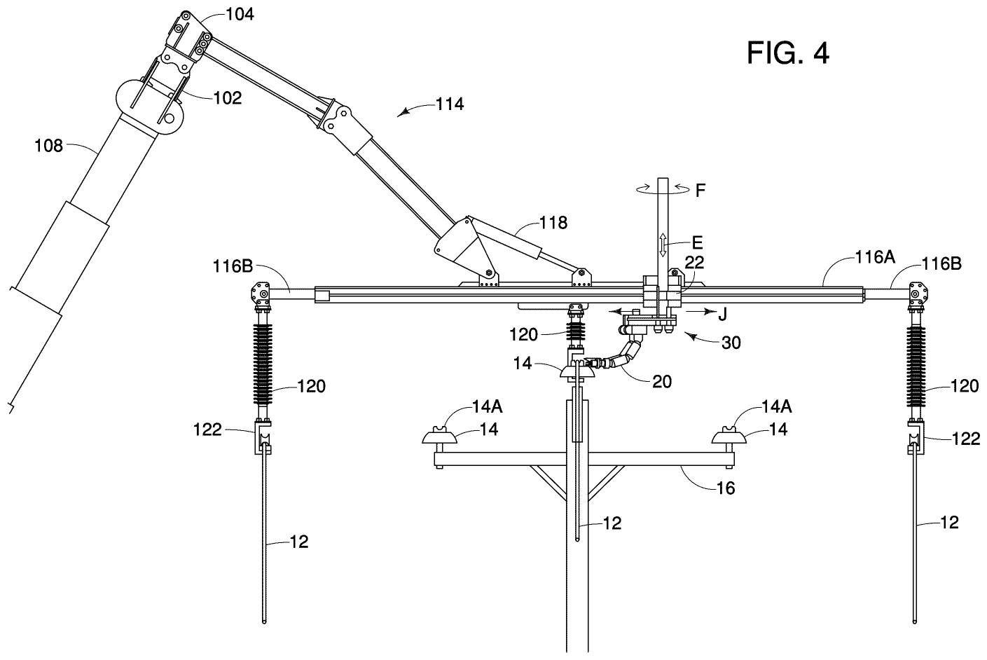

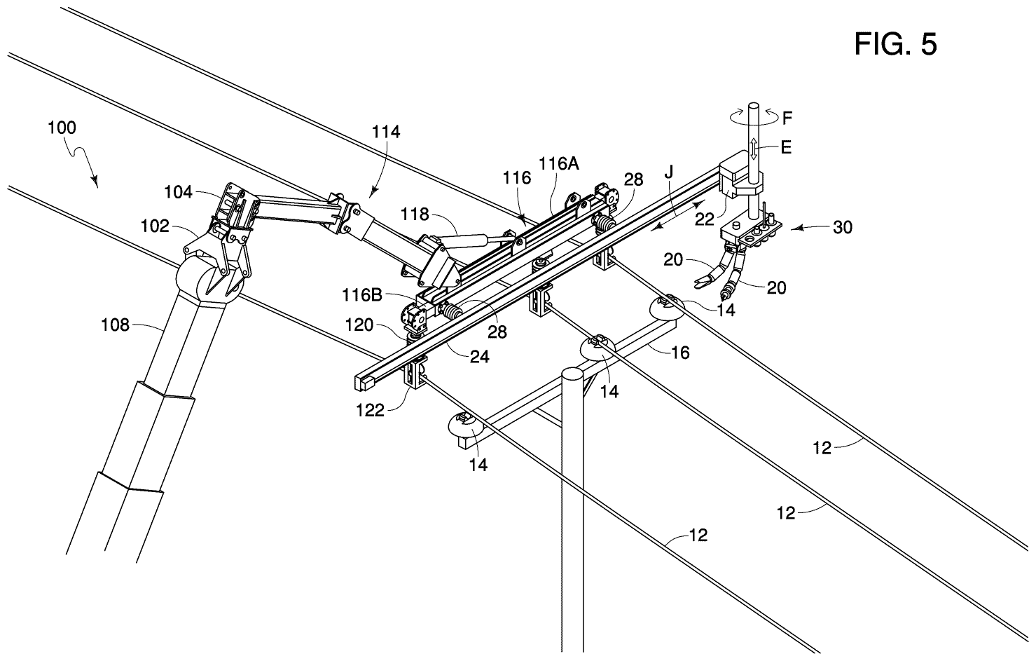

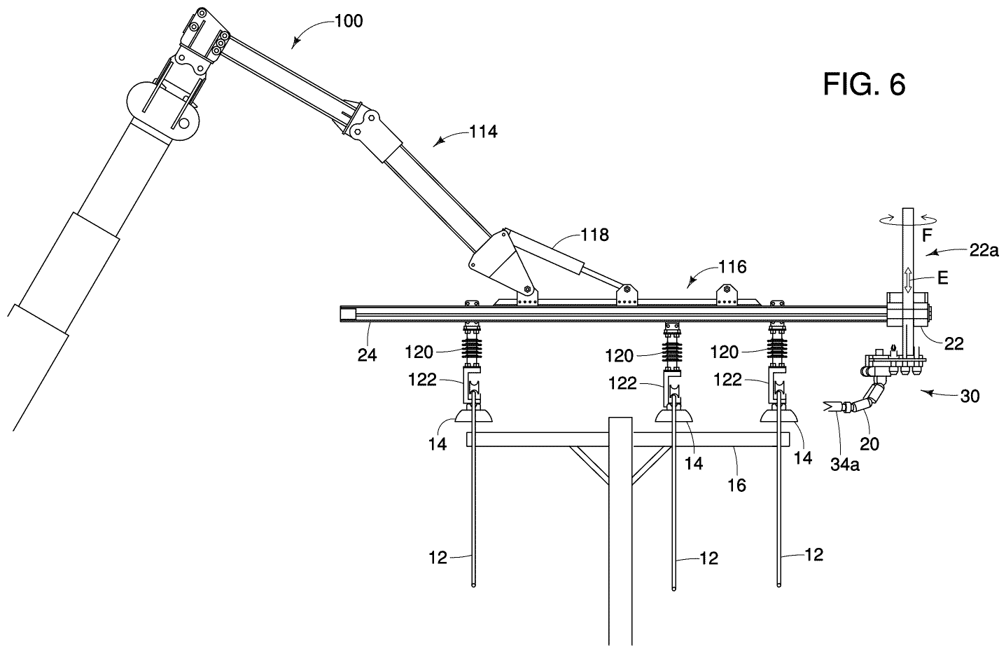

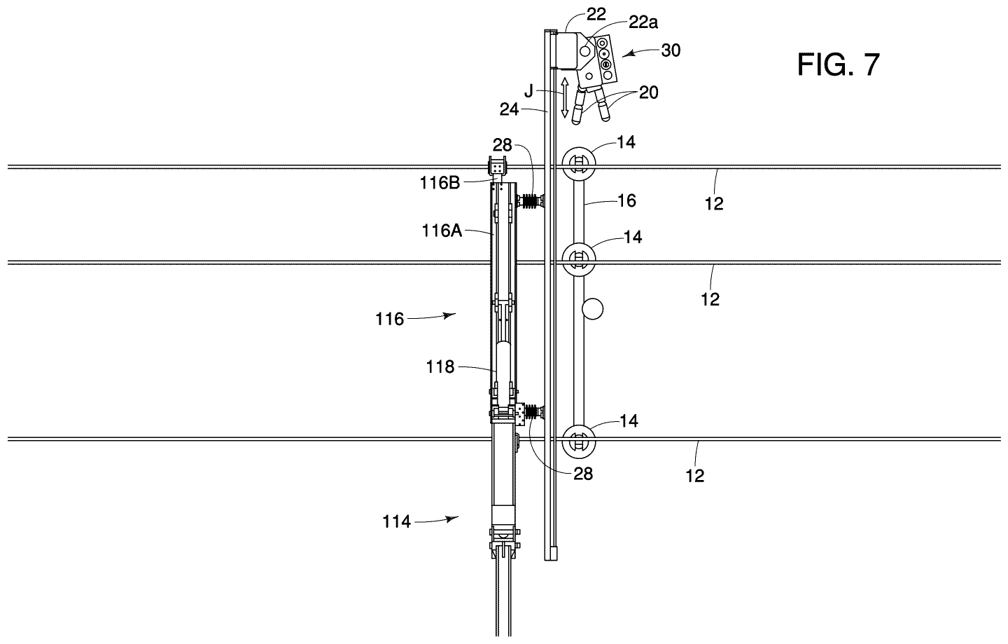

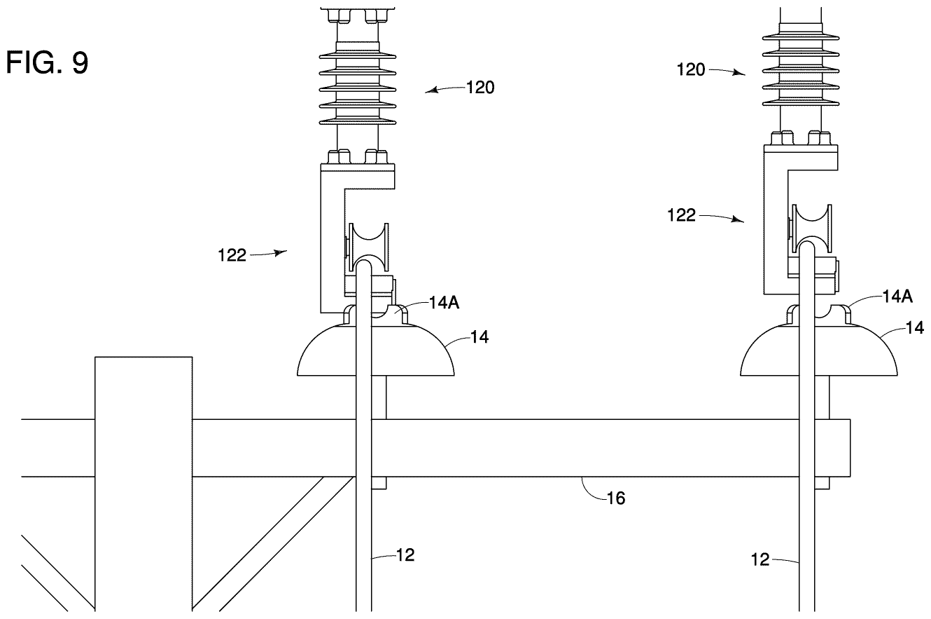

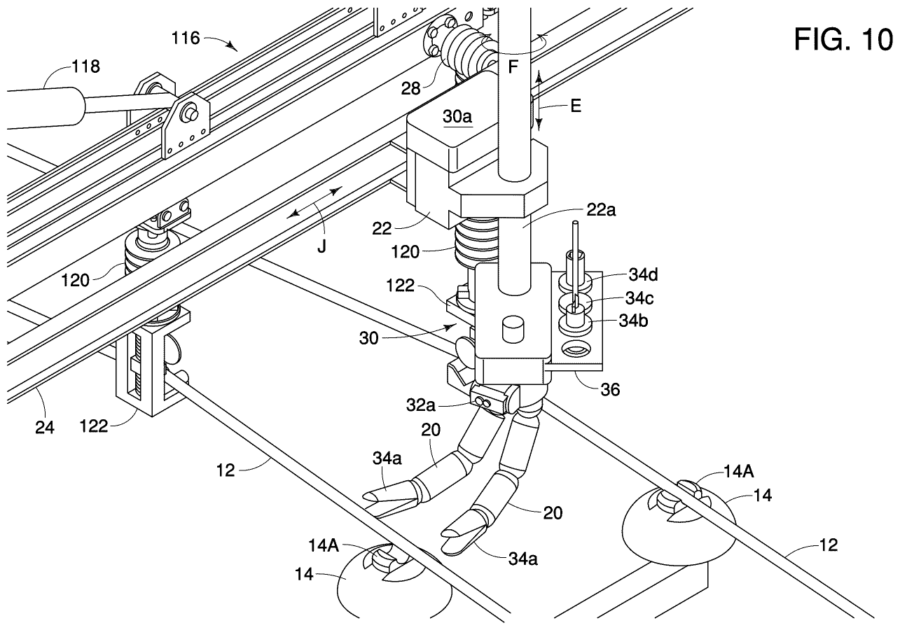

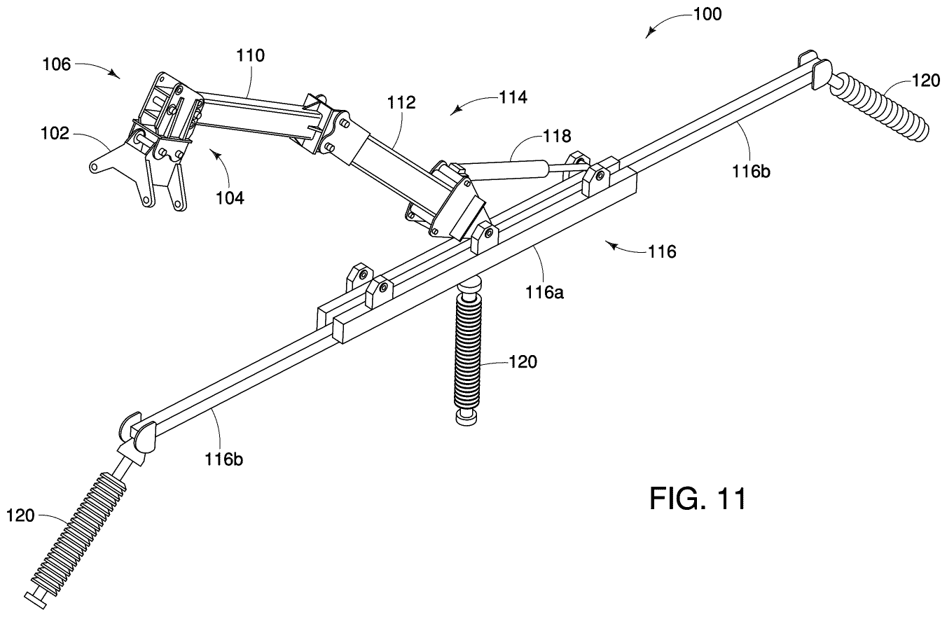

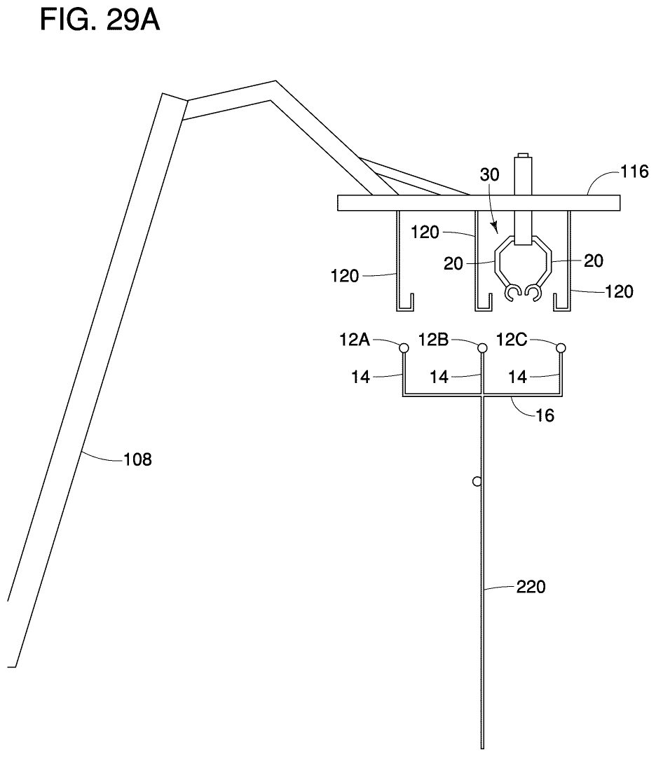

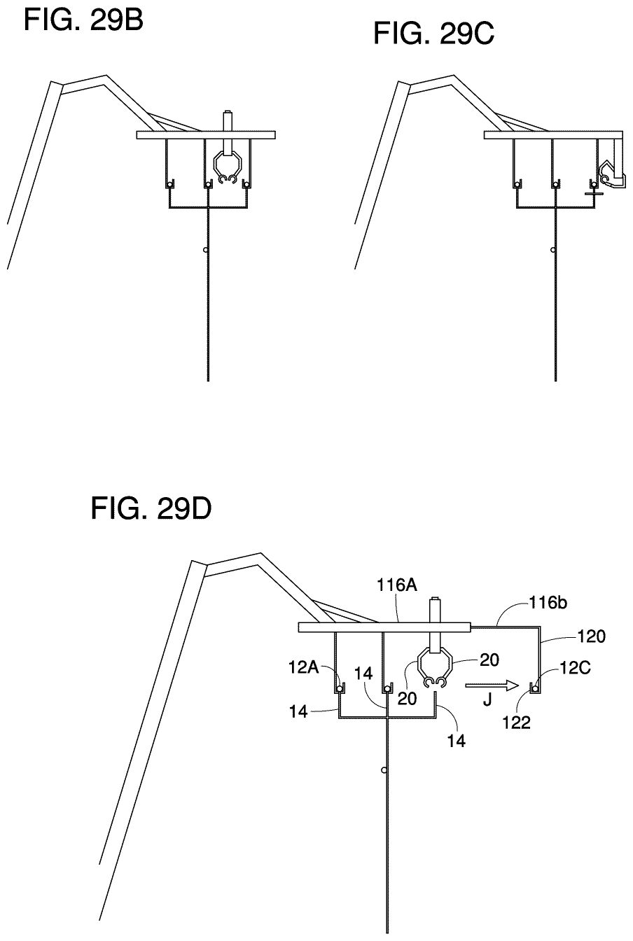

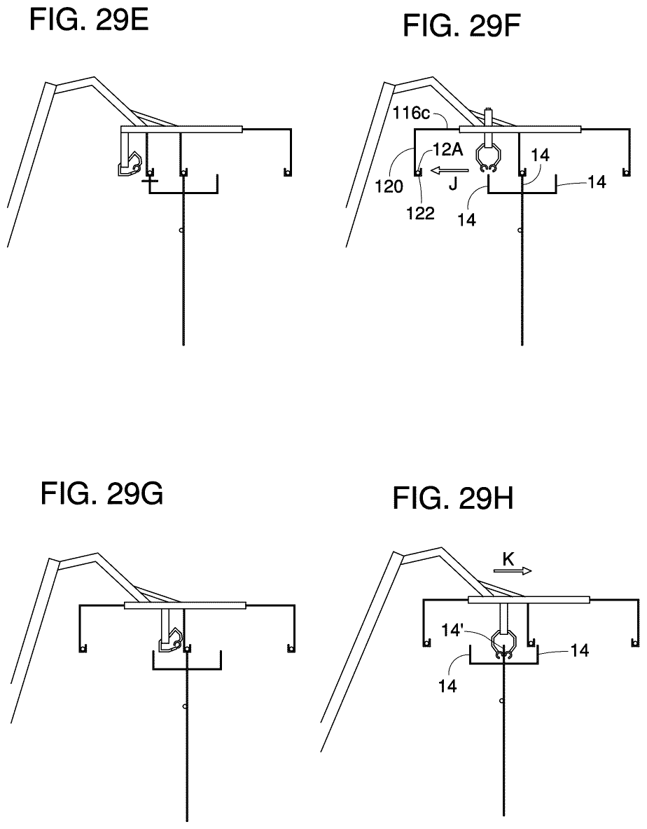

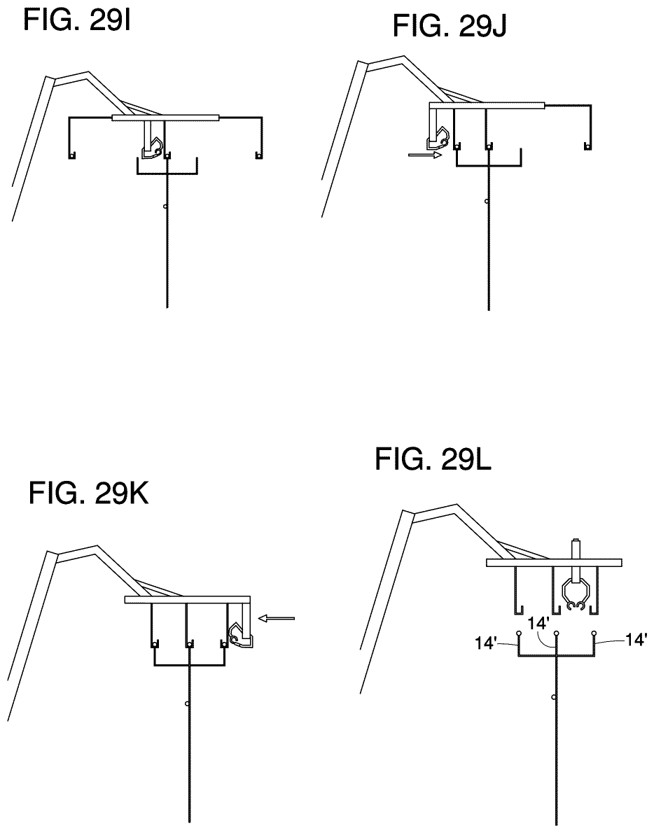

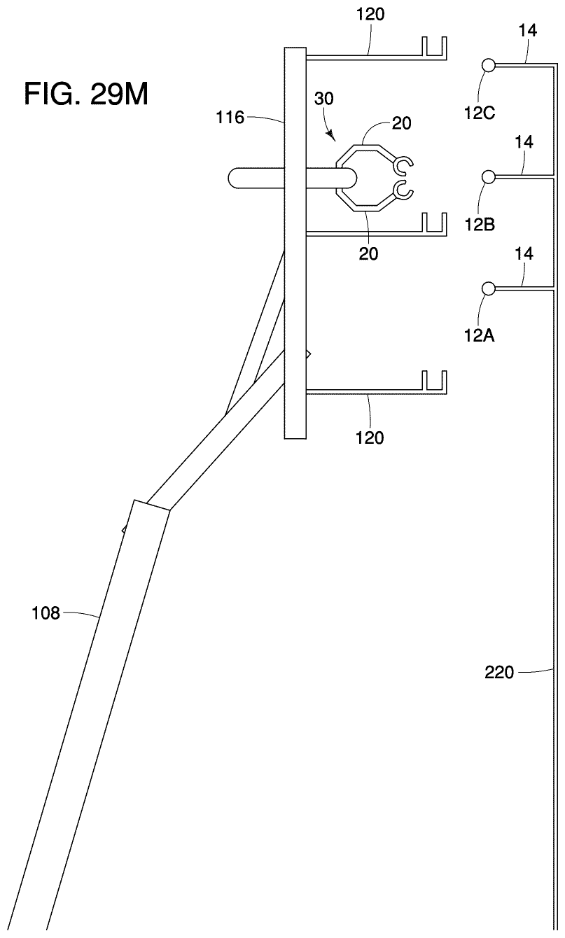

FIGS. 29A-29L graphically illustrate front elevation views of an insulator changing procedure performed by robot 30 (e.g., as depicted in FIGS. 3-10), consistent with disclosed embodiments.

Initially and as depicted in FIG. 29A, robot 30 may be positioned so as to approach conductors 12 safely and with precision (e.g., along one or more path plans and moved by a mechanical translator). Then as depicted in FIG. 29B, wire cages may be connected to each conductor phase and securely fastened. Then as depicted in FIG. 29C, robot 30 may disconnect the field phase from its insulator. Then as depicted in FIG. 29D, beam 116 may be extended (e.g., via telescoping arm 116B) to create a working window for facilitating the seamless replacement of the insulator 14. A similar procedure may be repeated for the road phase conductor, as depicted in FIGS. 29E and 29F, with its disconnection from the insulator 14 and the subsequent creation of a working window for replacement of the old insulator 14 with a new insulator 14′. Then as depicted in FIG. 29G, robot 30 may disconnect the center phase conductor from its insulator 14.

At this stage, the energized conductor phases are entirely free of the pole and cross arm structure, allowing for safer manipulation of electrical components in the working windows for any necessary activities (e.g., maintenance or repair operation). For example, a lineman (not shown) may ascend the structure to replace all three insulators 14 without being exposed to working directly on energized conductors. Alternatively, in the case of a pole change, the entire pole may be removed and replaced without risking the safety of the lineman.

In some embodiments, after each phase conductor is disconnected from its insulator and secured in a wire cage, robot 30 may perform repair or maintenance operations. For example, robot 30 may replace each insulator 14 with a new insulator 14′ instead of or alongside a lineman. For example, as depicted in FIG. 29H, robot 30 may be positioned near center phase insulator (e.g., by a mechanical translator following a path plan) and may replace center phase insulator 14 with a new insulator 14′. Then as depicted in FIG. 29I, the center phase conductor is securely relocated and secured in its new insulator 14′. The road phase and field phase are similarly repositioned and secured in their respective new insulators 14′, as depicted in FIGS. 29J and 29K, respectively. Finally, as depicted in FIG. 29L, each conductor phase is released from the corresponding wire cages (e.g., by robotic manipulator arm 20 and end effector 34).

FIG. 29M illustrates the diagrammatic commencing of the insulator changing procedure of FIGS. 29A-29L when the beam 116 of a robotic arm is vertically oriented and the insulators 14 are horizontally oriented and mounted on pole 220, consistent with disclosed embodiments. One skilled in the art will appreciate that the procedure of FIGS. 29A-29L may be similarly followed except reoriented by 90 degrees, with beam 116 in a vertical orientation and the insulators 14 horizontal in order to replace insulators 14 on pole 220 with new insulators 14′.

### Tie Wire: Wrapping of Tie Wire by Robotic Manipulator Arms

In one non-limiting example, once the robotic manipulator arms 20 and their end effectors 34 are positioned above the insulator 14, the tie wire dispenser mechanism is activated (e.g., by a logic unit or computer). The tie wire dispenser may feed out a length of tie wire appropriate for the specific insulator size and installation requirements. For example, a logic unit or computer may determine the length of tie wire based on predetermined associations between tie wire length and a specific insulator size and installation requirement stored in a memory operably coupled to the logic unit (e.g., look-up table). In some embodiments, grippers 34a may be configured to grasp an end of the dispensed tie wire 18 securely. Then grippers 34a may manipulate tie wire 18 (e.g., a middle portion) to wrap it around a top of insulator 14, leaving a length of tie wire 18 extending from opposite sides of insulator 14 (e.g., a first end and a second end). Grippers 34a may maneuver insulator 14, wrapping each end of the tie wire 18 tightly and securely in a spiral around the conductor 12, as further exemplified and described elsewhere herein.

In some embodiments, robotic system 100 may include one or more gripper force sensors. For example, one or more gripper force sensors (not shown) may be configured to sense a tension applied to tie wire 18 during wrapping and may transmit the sensed tension to a logic unit or computer of robot 30. The logic unit or computer of robot 30 may control grippers 34a to ensure adequate tension is applied to tie wire 18 during wrapping. After wrapping tie wire 18 around the insulator 14, a logic unit or computer of robot 30 may perform one or more verification checks to ensure proper installation of the tie wire, based at least in part on the received data from the one or more gripper force sensors. The logic unit may analyze the sensor data and visual feedback from the sensors and/or the one or more cameras to confirm that tie wire 18 is securely fastened and meets pre-set quality standards (e.g., as stored in a memory). In some embodiments, after determining that tie wire 18 is not securely fastened or does not meet pre-set quality standards, logic unit may initiate one or more corrective actions (e.g., untie tie wire 18 and re-tie tie wire 18) or may generate an alert to an operator for manual intervention (e.g., audio alert, visual alert, haptic alert). In some embodiments, after determining that tie wire 18 is securely fastened and meets pre-set quality standards, the logic unit may instruct the robotic manipulator arms 20 to release the insulator 14. The logic unit may further command the robotic manipulator arms to retract and to move on to the next insulator location along the planned path, at which location a similar sequence of operations may be performed on the next insulator.

### Tie Wire: Removal of Tie Wire by Robotic Manipulator Arms

In some embodiments, once the work environment information is known, robot 30 may commence work under the remote control of an operator or may run through an automated sequence to perform the work. For example, after determining the one or more path plans based on the sensed at least one parameter by sensor package 32, robot 30 may utilize a ring to connect to tie wire 18 and to rotate tie wire 18, thereby removing tie wire 18 from conductor 12. Additionally or alternatively, in some embodiments, robot 30 may include a saw blade 34c, such as reciprocating saw blade, to remove tie wire from the insulator via cutting. By way of non-limiting example, saw blade 34c may be aligned horizontally in a horizontal plane containing the tie wire location where cutting is desired. The logic unit may activate saw blade 34c to reciprocate the saw blade and to translate horizontally (e.g., by its robotic manipulator arm 20) in the horizontal plane until tie wire 18 is cut through without touching the insulator 14. The logic unit may then instruct saw blade 34c to retract horizontally; to swing 180 degrees (e.g., directly over insulator 14); to translate in the horizontal plane back into contact with tie wire 18, this time on the opposite side of insulator 14; and to cut through tie wire 18 again without contacting insulator 14. In this way, tie wire 18 may be removed (e.g., falls away or is pushed away by end effector 34), and the corresponding conductor 12, which is already secured in the corresponding wire cage on the insulators extending downwardly from the beam of the robotic arm, may be lifted and moved away by raising and moving away the robotic arm.

In embodiments in which tie wire 18 is to be removed by unwrapping from conductor 12 and insulator 14 instead of being cut by a saw blade 34c, grippers 34a may be used instead or in addition to saw blade 34c. Grippers 34a may be positioned close to the tie wire 18 to be removed. Grippers 34a may grasp tie wire 18 firmly and apply appropriate tension (e.g., as sensed by a gripper force sensor and processed by a logic unit or computer) to ensure effective removal without damaging insulator 14 or conductor 12. In embodiments employing two robotic manipulator arms 20, grippers 34a may be mounted on a first robotic manipulator arm and snippers 34b may be mounted on the second robotic manipulator arm. Snippers 34b may be configured to cut the tie wire once tying is complete.

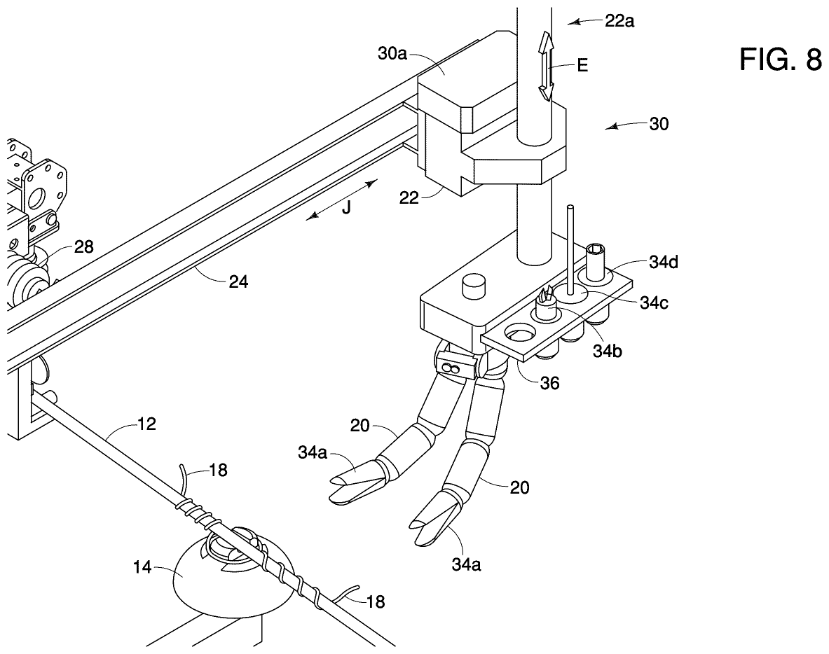

End effectors 34 may be stored in a rack 36 (e.g., as depicted in FIG. 8) for ease of retrieval and automated switching of end effectors 34 on robotic manipulator arms 20. After removal of tie wire 18, robotic system 100 may perform one or more verification checks to ensure successful removal. For example, the logic unit may analyze sensor data and visual feedback from the sensors or the one or more cameras to confirm that tie wire 18 has been fully removed and there are no residual fragments left on insulator 14. After determining successful removal of tie wire 18, robotic manipulator arm 20 may release the gripped end of the wire (e.g., open grippers 34a). Then the robotic manipulator arms 20 may retract, and robot 30 may move on to the next insulator location along the planned path, following the same or similar sequence of operations.

In some embodiments, robotic system 100 may be autonomous or semi-autonomous. For example, the performance of the various sequences of steps may be recorded and stored in a memory accessible by the logic unit. Further, sensor data output (e.g., all) may be stored and utilized by the logic unit to update the sequences and processes to create a more efficient process in the future. For example, the logic unit may be configured to analyze the sensor data output to determine a more optimal path plan (e.g., satisfies more constraints or better satisfies constraints). Furthermore, in some embodiments, the sequences may be performed in reverse. For example, high-dexterity manipulator arm end effectors such as specialized grippers 34a or claws 34f may go through successive rotations in direction I to remove and replace tie wire 18.

### Replacing Insulators Using Robotic Manipulator Arms

FIGS. 29A-29L illustrate an inverted robotic arm, the beam 116 of which is attached a slide rail 24 as described above with respect to FIGS. 3 and 3A, allows robot 30 to be positioned by lowering the robotic arm, the slide rail 24, and robot 30 so that the insulators 120 depending downwardly from the beam 116 are lowered into position from above the conductors 12. Thus, in some embodiment, an inverted robotic arm is used to lower insulators 120 and wire cages 122 down near conductors 12 in order to facilitate the picking each of the three phases of conductors 12 and to move the conductors 12 up and out of the way to allow for the replacement of the old insulators 14 with new insulators 14′. In some embodiments, picking conductors 12 into wire cages 122 may be done conventionally (i.e., by a lineman).

Additionally or alternatively, in some embodiments, picking conductors 12 into wire cages 122 may be done by robotic manipulator arms 20. For example and as depicted in FIGS. 31 and 32, a socket wrench tool 34d on a robotic manipulator arm 20 may be employed to clamp the conductor into the corresponding wire cage 122. In the illustrated example of FIGS. 31 and 32 (and also shown in FIGS. 3 and 3A), wire cage 122 has a frame 122a which supports a lead screw drive 122b for raising and lowering sheave wheel 122c so as to clamp and unclamp a conductor 12 in the wire cage 122. The socket wrench tool 34d may be used to engage a drive nut (not shown) protruding from the screw drive such that rotation of the drive nut causes rotation of the lead screw 122d. Depending on the direction of rotation of the drive nut, and the corresponding direction of rotation of the lead screw, sheave wheel 122c may either be raised or lowered in direction H. Lowering the sheave wheel onto the conductor 12 may secure the conductor in the wire cage. Raising the sheave wheel may release the clamping of the conductor between the sheave wheel 122c and rollers 122e, thereby opening the wire cage 122.

Once the manipulator arms 20 have secured the conductors 12 in their corresponding wire cages 122, robot 30 may be moved (e.g., along one or more path plans by a mechanical translator) to the location of the first insulator to be replaced, for example the field insulator. Once in position, manipulator arms 20 and their corresponding end effectors 34 may disconnect the field phase 12C from its insulator 14. The telescopic arm 116B may then extend in direction I (e.g., as depicted in FIG. 29D) to create a working window where the separation distance does not encroach the corresponding limit of approach, thereby facilitating a safer insulator change. Similarly, robot 30 may repeat this process for the road phase 12A, disconnecting it from its insulator 14 and extending the road phase 12A suspended from its insulator 120 on telescopic arm 116C away in direction J (e.g., as depicted in FIG. 29F) thereby creating another working window for insulator 14 replacement. The center phase 12B may then be picked and secured in the wire cage on the center insulator 120 and moved away from the center phase insulator 14 (e.g., as depicted in FIG. 29H). In some embodiments, after all conductor phases are free from the pole and cross arm structure, a lineman may safely carry out activities such as changing insulators or replacing the pole without direct exposure to energized conductors. Additionally or alternatively, in some embodiments, robot 30 may perform a repair or maintenance operation instead of or alongside a lineman. For example, robotic manipulator arms 20 may replace the insulator 14 with a new insulator 14′. After the repair or maintenance operation is completed, robot 30 may ensuring each phase is securely moved back to its original location and fastened in the new insulator 14′ with new tie wire. Finally, the wire cages are removed from each phase.

To restate, wire cages are used to secure each conductor, thereby mitigating the risk of accidental contact and promoting a safer working environment. Once secured, the robotic manipulator arms 20 may disconnect the field phase 12C from its insulator 14 by manipulating robotic manipulator arm 20 with dexterity to execute the task without disrupting nearby components. Following the disconnection, beam 116 may be extended (e.g., via extendable or telescopic arms 116B and 116C) to create a calculated working window to facilitate the seamless replacement of the insulator. This strategic extension of beam 116 allows robot 30 or a lineman to operate within the constrained space, ensuring optimal clearance. With the insulator changed, the process may be similarly repeated for the road phase, with the robotic manipulator arms 20 picking road phase 12A into a corresponding wire cage 122 and creating another working window for insulator replacement, all while adhering to the applicable safety protocols as would be known to a lineman skilled in the art. Continuing the sequence, the robotic manipulator arms 20 may systematically proceed with the insulator changes for the center phase 12B and then relocating each phase back to its original position and securing it in the new insulator 14′.

Thus, robotic manipulator arms 20 offer completion of a minimum amount of work in close proximity before relocating conductors to a safer location further away. The robotic manipulator arms 20 may navigate tight spaces with precision, minimizing the risk of contact with energized lines and obstructions. By performing initial tasks close to the work area and then relocating conductors to a safer distance, robot 30 may streamline the conventional process and reduce the need for multiple movements and the presence of a lineman doing the repetitive tasks, thus enhancing efficiency and safety. Robotic manipulator arms 20 work well within open spaces above a pole, especially when mounted as described above from an inverted robotic arm, thereby eliminating the need to work from below the insulators 14. Working from below insulators 14 may possibly encroach on the limits of approach for underbuilt utilities or structures.

Unlike human linemen, robots are not constrained by the limitations of physical posture or workspace, allowing them to operate efficiently without risking damage to surrounding infrastructure. By working from above (e.g., suspended from an inverted robotic arm), the robot bypasses the need to navigate crowded spaces below, which may streamline operations and may minimize the risk of accidents or interruptions caused by encroaching on underbuilt utilities or structures. Moreover, the robot's structure negates concerns about ergonomics for linemen, further enhancing its effectiveness in completing tasks safely and efficiently.

Although the above description refers to an inverted robotic arm, it may be appreciated that the robotic arm may instead be employed right side up instead of inverted with its insulators 120 adapted to suspend upwardly from the beam 116 of the right-side-up robotic arm, to which is attached a slide rail 24 via stand-off insulators 28.

Using an inverted robotic arm, slide rail 24 may be positioned and lowered so that the insulators 120 depending downwardly from robotic arm may be lowered into position from above, and aligned with, the conductors 12. In some embodiments, an inverted robotic arm may be used to lower insulators 120 down onto the conductors 12 in order to facilitate a picking of each of the three phase conductors and to move them up and out of the way to allow for the replacement of the insulators 14. The slide rail 24 may be mounted on horizontal stand-off insulators 28 from one side of beam 116, so as to run parallel with the beam 116. Carriage 22 may be mounted to slide rail 24 on opposite sides to stand-off insulators 28. In this way, carriage 22, and robot 30 mounted thereon, may slide along slide rail 24 without interference with insulators 28. It is understood that insulators 28 may include any suitable number (e.g., one, more than two) based on the weight to be supported. For example, if insulators 28 are longer than the illustrated pair of insulators 28 (e.g., due to increased voltage in the conductors 12), the weight being supported by robot 30 may cause excessive bending moments on insulators 28, which may lead to structural failure of insulators 28. In such an example, additional insulators 28 between slide rail 24 and beam 116, including beam housing 116A, may be required.

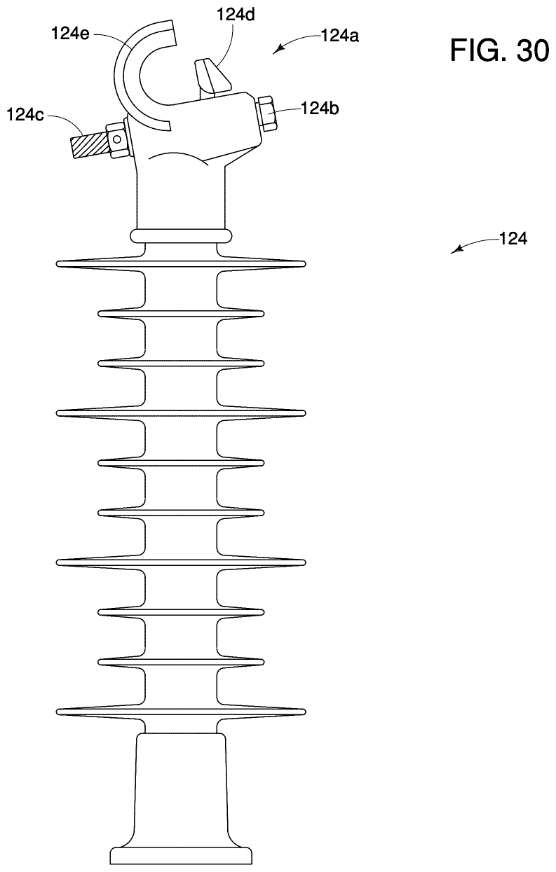

In some embodiments, insulators 14 may be secured to conductors 12 without tie wires. For example, insulator 124 is depicted in FIG. 30, which shows a side elevation view a model KL69S insulator from K-Line Insulators Limited of Toronto, Ontario, Canada. Insulator 124 includes a mechanical clamp 124a, which may be opened and closed using an end effector tool such as socket wrench tool 34d on a robotic manipulator arm 20. Socket wrench tool 34d may engage nut 124b so that rotation of socket wrench tool 34d and nut 124b also rotates shaft 124c. Rotation of shaft 124c may translate movable clamp arm 124d relative to fixed clamp arm 124e so as to clamp or unclamp a conductor within clamp 124a.

In some embodiments, a robotic system may comprise a beam and three insulator assemblies, each corresponding to a different conductor of a three phase circuit. An insulator assembly may comprise a first insulator, a robot, a second insulator, and a wire cage. For example, each insulator assembly may be mounted downwardly on beam 116, which may include telescopic arms 116B and 116C. First insulator 120 may be connected at a first end to beam 116 and positioned downwardly with respect to beam 116. A robot 30 may be connected at a first end of robot 30 to a second end of first insulator 120. A second insulator 120a may be connected at a first end to a second end of robot 30. In some embodiments, second insulator 120a may be shorter than insulator 120. A wire cage 122 may be connected to a second end of second insulator 120a.

In some embodiments, the main housing of each robot 30 may be selectively rotatable so as to swing the length of the housing toward the nearest insulator 14 so that the robotic manipulator arms 20 can reach the insulator 14 in order to perform a repair or maintenance operation. In some embodiments, telescopic arms 116B and 116C may be extendable or retractable to position robot 30 near a corresponding conductor. For example, telescopic arm 116C may be extended to position a corresponding insulator assembly near road phase 12A, and telescopic arm 116B may be extended to position a corresponding insulator assembly near field phase 12C. In this way, robotic manipulator arms 20 may operate to untie and pick the corresponding conductor phase 12A and 12C into their corresponding wire cages 122. Further, the robotic manipulator arms 20 may then close the wire cages 122 to secure the corresponding conductor therein.

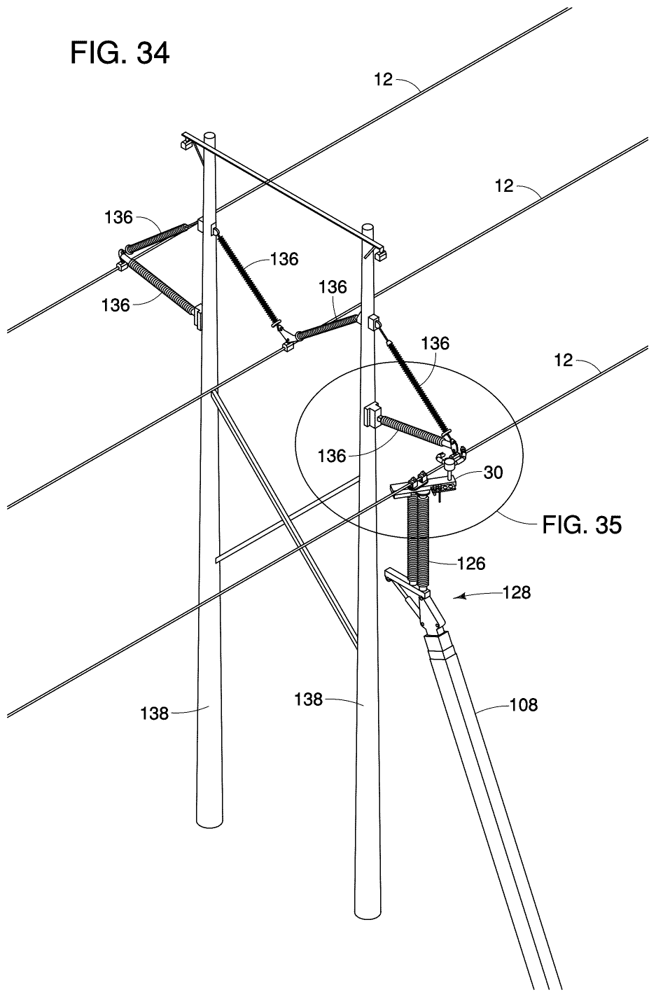

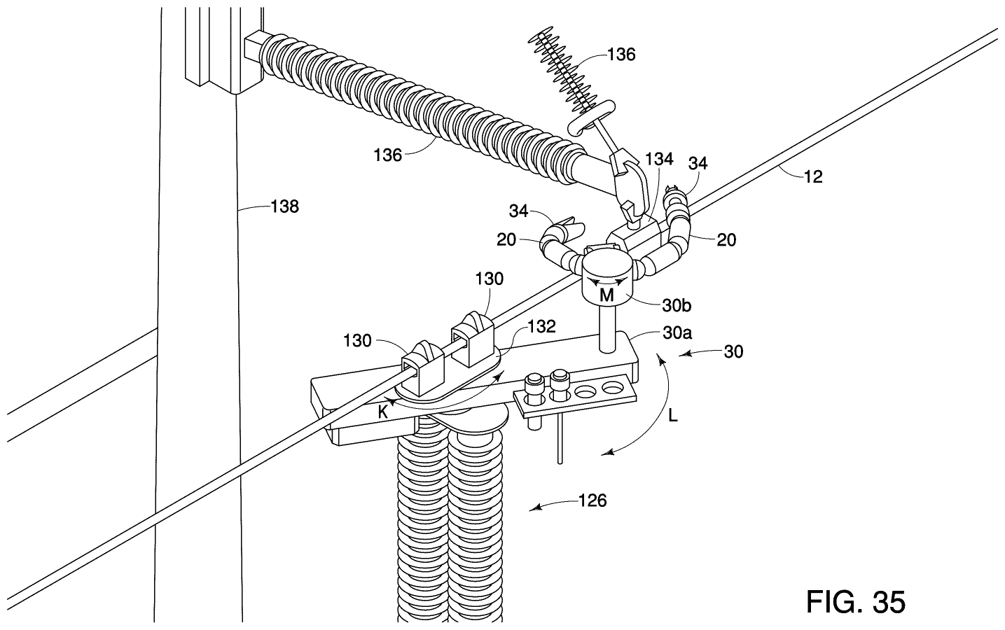

FIGS. 34 and 35 illustrate another example embodiment of a robotic system for repairing or maintaining an electrical component connected to a conductor, the system having a single robot mounted on a single pick, consistent with disclosed embodiments. As depicted in FIGS. 34 and 35, a robot 30 may be mounted a pair of vertical insulators 126, which are mounted on the end of single pick support 128. As depicted in FIG. 35, wire cages 130 secure a conductor 12 on a plate 132, which may be fixed or free to rotate in direction K about a vertical axis of rotation so as to align the wire cages with the conductor. Wire cages 130 may hold the conductor steady and in proximity to the pair of robotic manipulator arms 20 so that robotic manipulator arms 20 may release (and later re-secure) conductor 12 from where it is secured in a cable clamp 134 to the intersecting ends of the pole insulators 136 on poles 138. In some embodiments, robot 30 may be rotatably mounted on the uppermost ends of the pair of insulators 126 so that it may selectively rotate in direction L to bring its robotic manipulator arms 20 into working proximity to cable clamp 134. In some embodiments, robotic manipulator arms 20 may be rotatably mounted onto the main housing 30a of robot 30 for selective rotation in direction M of arm housing 30b relative to main housing 30a, thereby assisting in positioning robotic manipulator arms 20 into a position and proximity to do the required repair or maintenance.

### Inverted Robotic Arm

In jurisdictions where allowed, U.S. patent publication number US 2021/0273424 A1, published Sep. 2, 2021, and entitled “Mounting A Robotic Arm In An Inverted Position To Suspend An Electrical Bypass” is incorporated herein by reference in its entirety. What follows is included for the benefit of this specification in jurisdictions that do not allow for incorporation by reference.

In order to invert a robotic arm, such as a LineMaster™ robotic arm, which is typically used with station-class electrical insulators, the uppermost end of a boom such as a crane or truck boom, on which the LineMaster™ robotic arm is mounted, is adapted, for example, by the use of a cantilevered supporting swing arm, to allow reorientation of the LineMaster™ robotic arm so as to invert it. The cantilevered swing arm may include a hinge coupler pivotally coupling the swing arm to the top of the boom, and an actuator at the opposite end of the swing arm so as to reorient the LineMaster™ robotic arm relative to its inverted orientation.

The swing arm, which extends downwardly from its hinge coupler, may include a boom adapter arm and an electrically insulated robotic arm jib mounted end-to-end. The lower end of the swing arm is pivotally coupled to the main beam of the LineMaster™ robotic arm. The hinge coupler is advantageously releasably lockable and may include a pivot linkage. The swing arm may for example include the elongate, directionally reversible boom adapter arm mounted end-to-end to the robotic arm jib. The upper end of the swing arm is pivotally mounted on the pivot linkage in the hinge coupler for releasably lockable pivoting of the swing arm about the pivot linkage relative to the free end of the crane or truck boom. The swing arm is thereby selectively orientable relative to the crane or truck boom downwardly into its operational orientation.

The LineMaster™ robotic arm is mounted upside down on the lowermost end of the swing arm so as to downwardly orient insulators 120 mounted on beam 116 of a robotic arm. For example, for use on live conductors of a three phase AC circuit such as illustrated, the LineMaster™ robotic arm will advantageously have three correspondingly spaced apart insulators 120. The insulators 120 may be station class insulators. The LineMaster™ robotic arm may also be used for live DC conductors, in which case the LineMaster™ robotic arm will have at least one, and likely two, downwardly extending insulators 120 extending downwardly therefrom. When the insulators 120 are oriented downwardly they may be described as being in oppositely disposed in relation to the swing arm 114 coupled to the LineMaster™ robotic arm. In the example provided in applicant's published '424 application, the lowermost free end of each insulator 120 is adapted for releasably holding an electrically energized electrical bypass which may include a rigid bus bar.

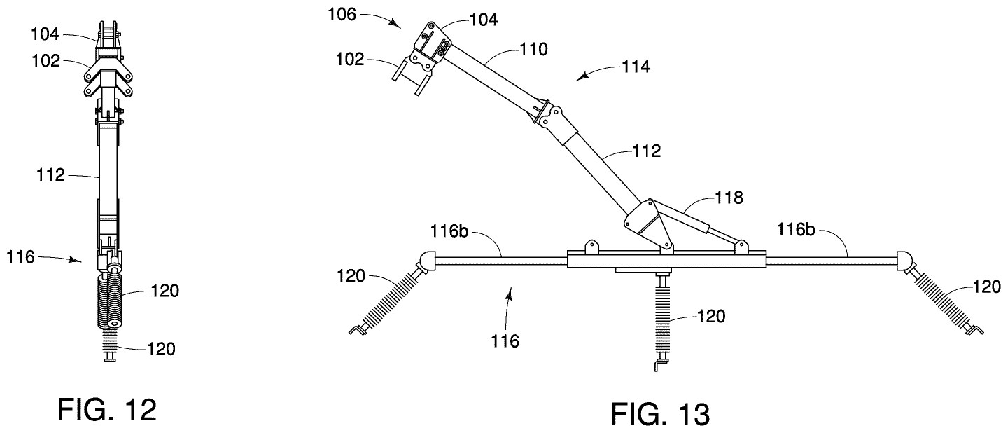

With reference to FIGS. 3 and 11-13, actuator 118 may cooperate between swing arm 114 and beam 116 of a robotic arm for selective rotation of beam 116 relative to swing arm 114 while the robotic arm is inverted. This configuration may be useful if, for example, the robotic arm is holding, suspended beneath it, a bus bar for electrically bypassing an electrical component needing repair or maintenance, such as a switch. The inverted robotic arm may support conductors 12 via its insulators 120.

With the swing arm 114 fixed in its position angled downwardly from the end of the crane or truck boom, the robotic arm is raised by extension of the crane or truck boom and the boom oriented to position the robotic arm. The robotic arm and boom orientation is adjusted using the actuator 118 and the boom actuator on the truck (not shown).

In some embodiments, the hinge coupler 104 may be mountable to a crane or truck boom adapter, for example a crane boom adapter 102 in the case of a crane boom, mounted onto the free end of the boom.

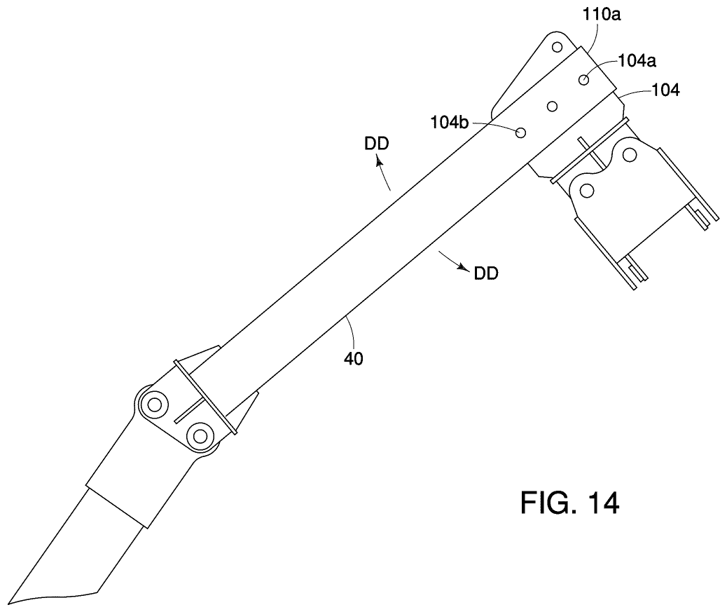

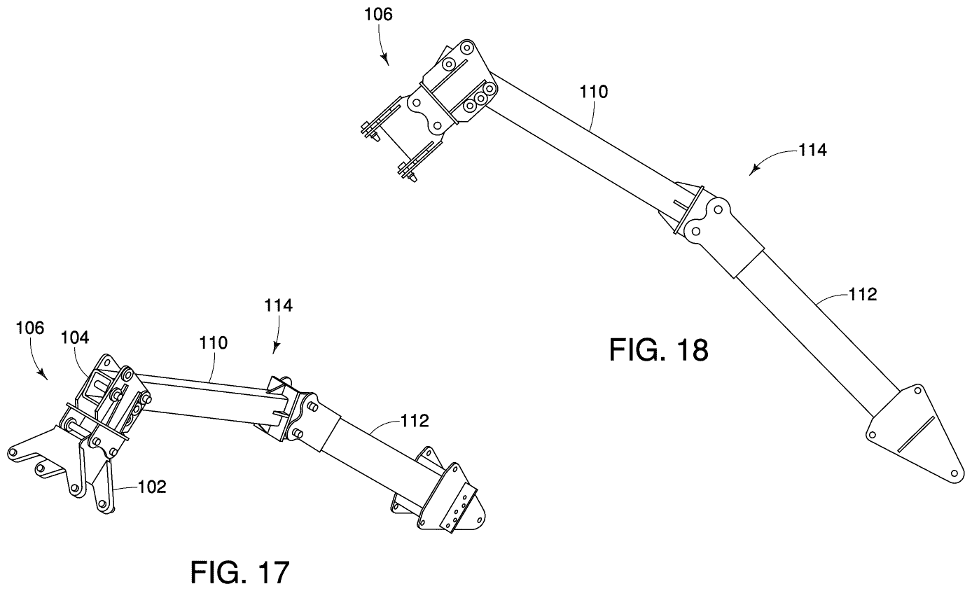

As depicted in FIGS. 14-19, the swing arm 114 may be locked in position so as to extend at an adjustable generally 90 degrees from the hinge coupler 104, for example, between about 75 degrees and 105 degrees, measured as the included angle between the crane or truck boom and the upper end of the swing arm. In some embodiments, the swing arm may be substantially 12 feet long.

In some embodiments, the swing arm and the robotic arm may lie substantially in a common plane. Further, in some embodiments, the actuator may rotate the robotic arm in that common plane. In some embodiments, robotic arm jib 112 may include an insulated section made from a rigid dielectric material, such as, for example, fiberglass.

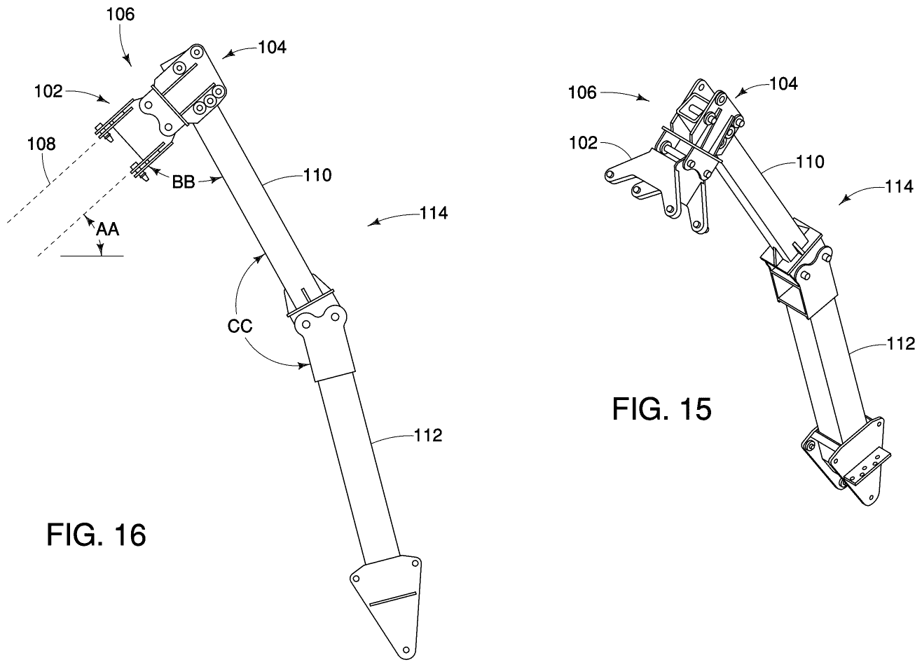

In some embodiments, the inverted robotic system 100 may include a crane or truck boom adapter 102 mounted to a hinge coupler 104, which may collectively provide an angling adapter 106. Crane or truck boom adapter 102 may mount onto the uppermost end of crane or truck boom 108, as also seen in dotted outline in FIG. 16. As depicted in FIG. 16, boom 108 may be, in operation, angled upwardly by angle AA relative to the horizontal. As seen in FIG. 16, angle AA may for example be about 45 degrees.

In some embodiments, boom adapter arm 110 may be pivotally mounted to hinge coupler 104 so as to depend downwardly therefrom, and in particular, so as to form an included angle BB (e.g., as depicted in FIG. 16) between boom adapter arm 110 and crane or truck boom 108. A robotic arm jib 112 may be mounted to the lowermost end of boom adapter arm 110 so as to extend approximately linearly therefrom (see included angle CC). Collectively, boom adapter arm 110 and robotic arm jib 112 may form swing arm 114.

As depicted in FIGS. 14-19, robotic arm jib 112 may be angled slightly further downwardly relative to boom adapter arm 110 so as to form an included angle CC of, for example, approximately 165 degrees. Beam 116 may be pivotally mounted to the lowermost end of robotic arm jib 112 for rotation in a plane, referred to herein as the common plane, which may include swing arm 114 and beam 116. In some embodiments, an actuator 118 (e.g., a hydraulic cylinder) may be mounted so as to cooperate between robotic arm jib 112 and robotic arm 116 and to selectively angularly position beam 116 relative to robotic arm jib 112.

In some embodiments, beam 116 may include a main beam housing 116A pivotally mounted to robotic arm jib 112 and having selectively extendable telescopic beam extensions 116B slidably mounted therein, which extend telescopically and linearly from opposite ends of main beam housing 116A. By way of non-limiting example, three station-class electrical insulators 120 may be mounted so as to depend downwardly from beam 116. In particular, one insulator 120 may extend downwardly from either end of extendable telescopic beam extensions 116B and 116C, and a third insulator 120 may extend downwardly from a position substantially midway along main beam housing 116A. Robotic system 100 may be used to position insulators 120 over, and thereby position robot(s) 30 so as to be near (e.g., adjacent to) electrical components (e.g., insulators 14) for their repair, maintenance or replacement.

As depicted in FIG. 13, insulators 120 may be angled outwardly from the ends of extendable telescopic beam extensions 116B. In this way, the spacing between the ends of the insulators 120 holding the three conductors 12 may be increased.

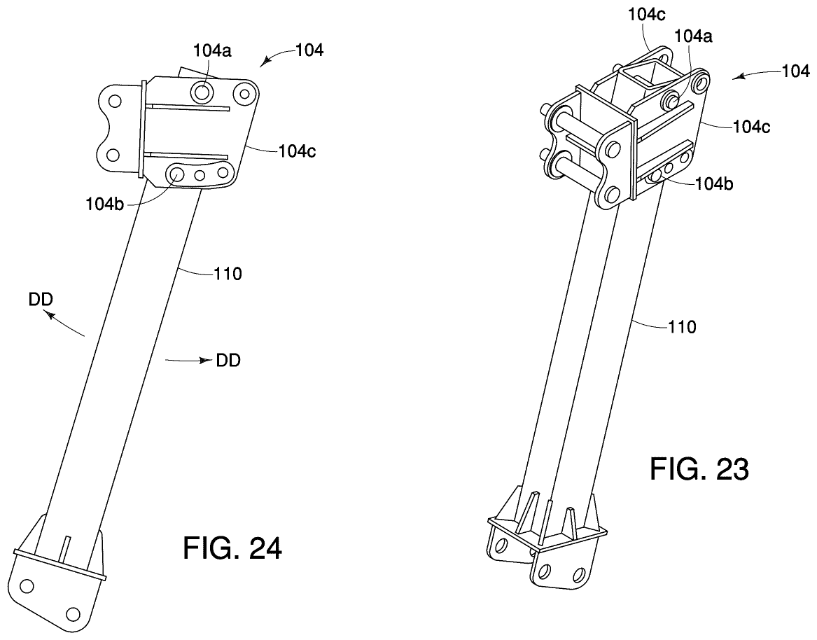

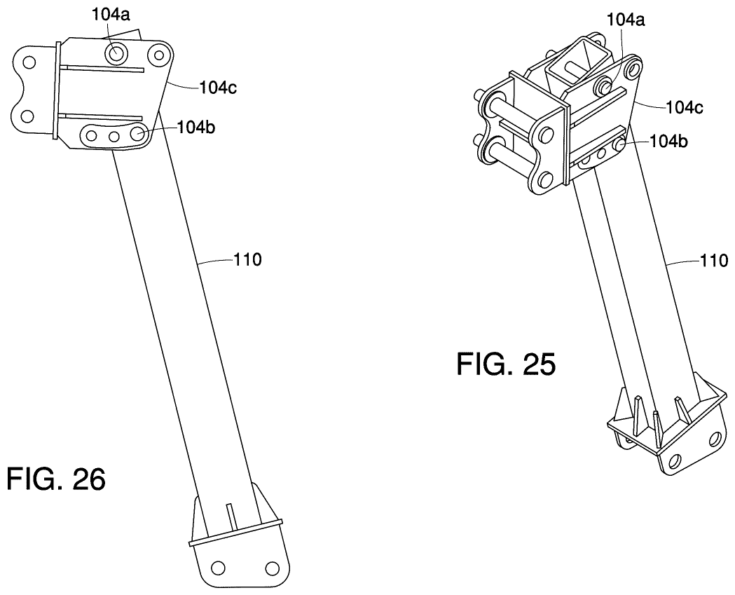

As depicted in FIG. 14, boom adapter arm 110 may be pivotally mounted within hinge coupler 104 by means of a hole and pin arrangement. In particular, and without intending to be limiting, the upper end of boom adapter arm 110 (labeled in FIG. 14 as end 110a) has a hole through which is journaled a first pin 104a, about which boom adapter arm 110 may be pivoted in direction DD. Once boom adapter arm 110 is pivoted in direction DD to the desired orientation, a second pin 104b may be inserted into a corresponding hole in boom adapter arm 110, which corresponds to matching holes in the sidewalls 104c of hinge coupler 104 (e.g., as depicted in FIG. 23).

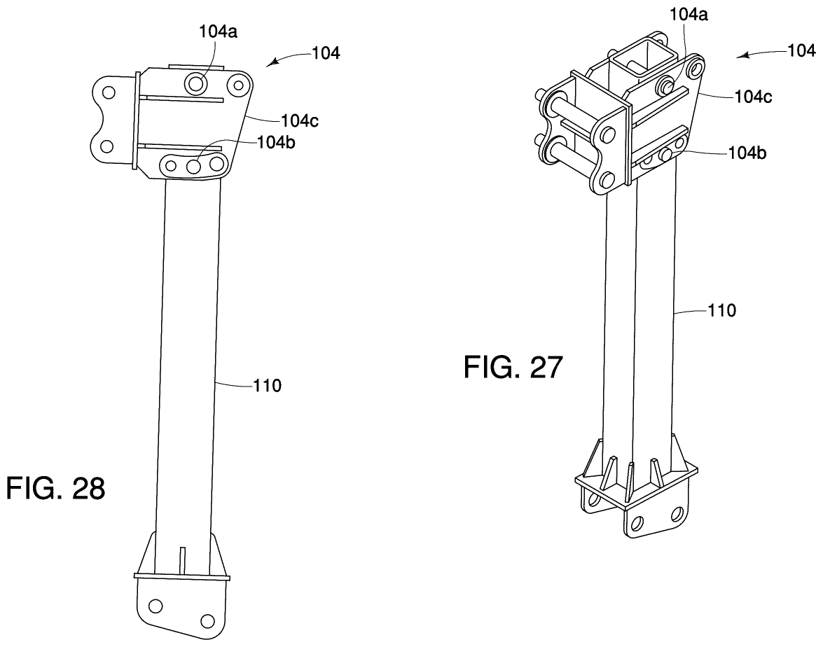

Thus, as depicted in FIGS. 23 and 24, boom adapter arm 110 may be free to rotate about first pin 104a when mounted between sidewalls 104c so as to angularly position boom adapter arm 110 to a desired angular orientation relative to hinge coupler 104. Once in the desired orientation, second pin 104b is inserted through correspondingly placed holes in sidewalls 104c and through the corresponding hole through boom adapter arm 110 so as to releasably lock boom adapter arm 110 in its desired position. In the orientation depicted in FIGS. 13 and 14, boom adapter arm 110 is fixed in a position rotated 15 degrees back from the 90 degree position seen in FIGS. 27 and 28 so as to be angled 15 degrees closer to crane or truck boom 108. In FIGS. 15 and 16 boom adapter arm 110 is angled oppositely so as to be angled 15 degrees ahead of the 90 degree position seen in FIGS. 27 and 28, thereby angling boom adapter arm 110 15 degrees further away from crane or truck boom 108.

FIG. 21 illustrates an example of a hinge coupler 104 including holes 129 through which first pin 104a may be inserted. Further, hinge coupler 104 may include holes 131 through which second pin 104b may be inserted depending on the desired angular position of boom adapter arm 110 when pivoted in direction DD about first pin 104a.

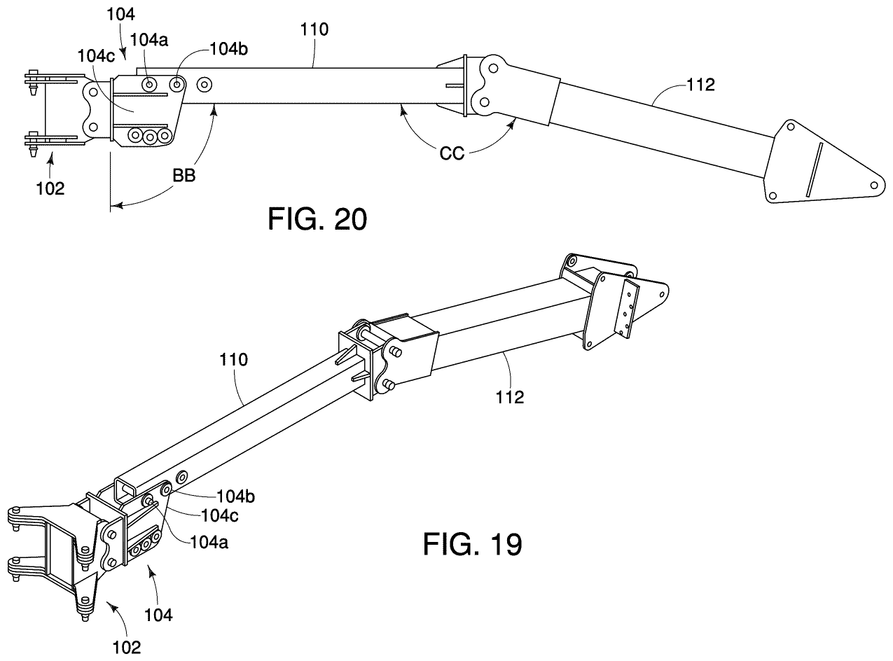

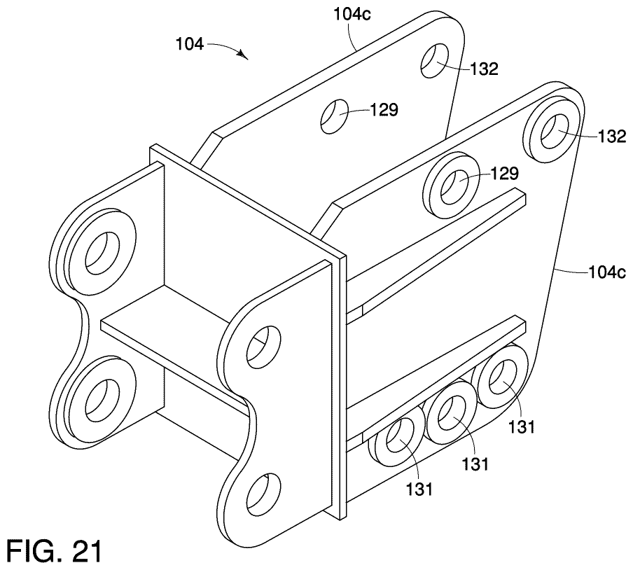

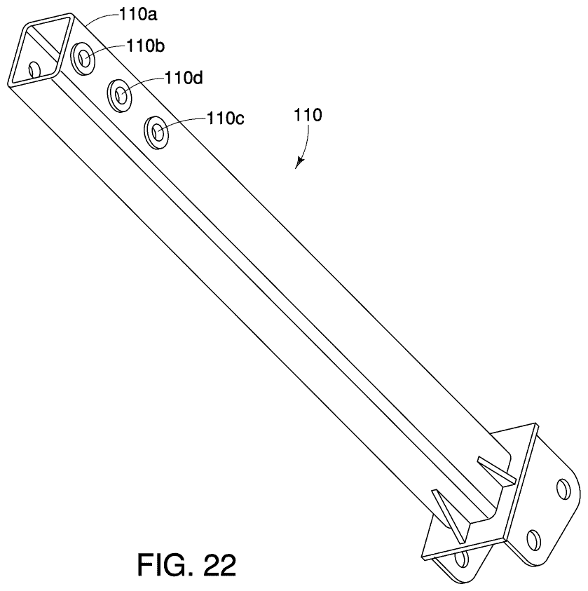

FIG. 22 illustrates an example of boom adapter arm 110, consistent with disclosed embodiments. The uppermost hole 110b in end 110a of boom adapter arm 110 may be the hole through which first pin 104a is inserted to allow the pivoting of boom adapter arm 110 in direction DD. Hole 110c may be provided for the insertion of second pin 104b so as to lock the angular orientation of boom adapter arm 110 about first pin 104a. Hole 110d may be provided when it is desired to rotate boom adapter arm 110 so as to be in line with crane or truck boom 108. As depicted in FIG. 19, second pin 104b may be inserted through holes in hinge coupler 104 and through hole 110d in boom adapter arm 110.

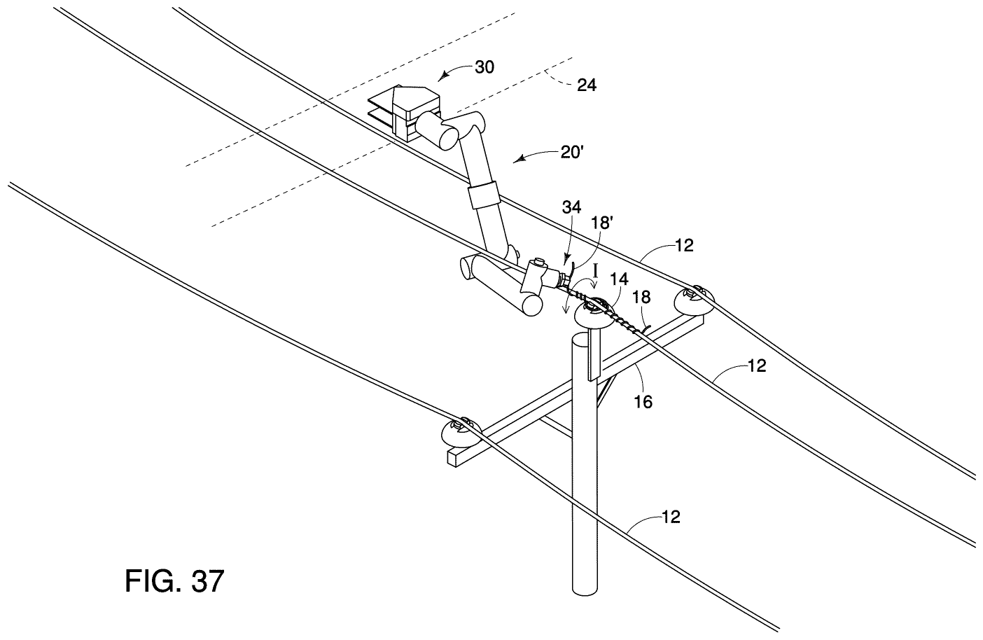

FIGS. 36-38 illustrate an example of a robotic manipulator arm 20′ having seven or more degrees of freedom. In general, it may be understood that robotic manipulator arm 20′ may be similar to and perform similar operations as robotic manipulator arm 20 and may only differ as explicitly described below. Having at least seven degrees of freedom may be useful for wrapping tie wire 18 onto conductors 12 via a spiral tie. In some embodiments, after: the old tie wire has been removed; the conductors have been lifted out of the insulators 14 and moved away; the insulator 14 has been replaced with a new insulator 14′; and the conductor 12 has been put back onto the new insulator 14′, new tie wire 18 may be used to secure the conductor 12 onto the new insulator 14′. To resecure the conductor onto the new insulator by spiral tying of new tie wire, the robotic manipulator arm 20′ may be curled around conductor 12 so as to provide for wrapping tie wire 18 in a spiral around conductor 12 with improved efficiency. By way of non-limiting example, end effectors 34 may include grippers 34a or claws 34f.

As depicted in FIG. 38, robotic manipulator arm 20′ and corresponding end effector 34 may provide improved dexterity so as to be curled in direction I about conductor 12. To spiral tie the tie wire 18, the end effector 34 may grasp tie wire 18 and may wrap a length of tie wire 18 about conductor 12 in a first direction along direction I so as to form a first spiral of tie wire around the conductor. The motion of robotic manipulator arm 20′—and in particular the motion of the corresponding end effector 34—may perform a full, substantially 360 degree encircling spiral wrap or may perform a partially-encircling spiral wrap (e.g., 180-270 degrees) encircling conductor 12 in the first direction, for example, over conductor 12 while holding tie wire 18. After performing the full or partial wrapping, robotic manipulator arm 20′ may release free end 18′ of tie wire 18 and may retract. Then end effector 34 on robotic manipulator arm 20′ may return to free end 18′ of tie wire 18 by moving robotic manipulator arm 20′, having been retracted, back towards the free end of the tie wire, for example, in a second direction opposite from the first direction (e.g., from underneath conductor 12). Free end 18′ of tie wire 18 is then regrasped by end effector 34 and the spiral wrap continues with a further full or partial wrap around the conductor, and so forth, until the full length of the spiral wrap is completed. The robotic manipulator arm 20′ may be mounted for translation along a slide rail 24, shown in dotted outline.

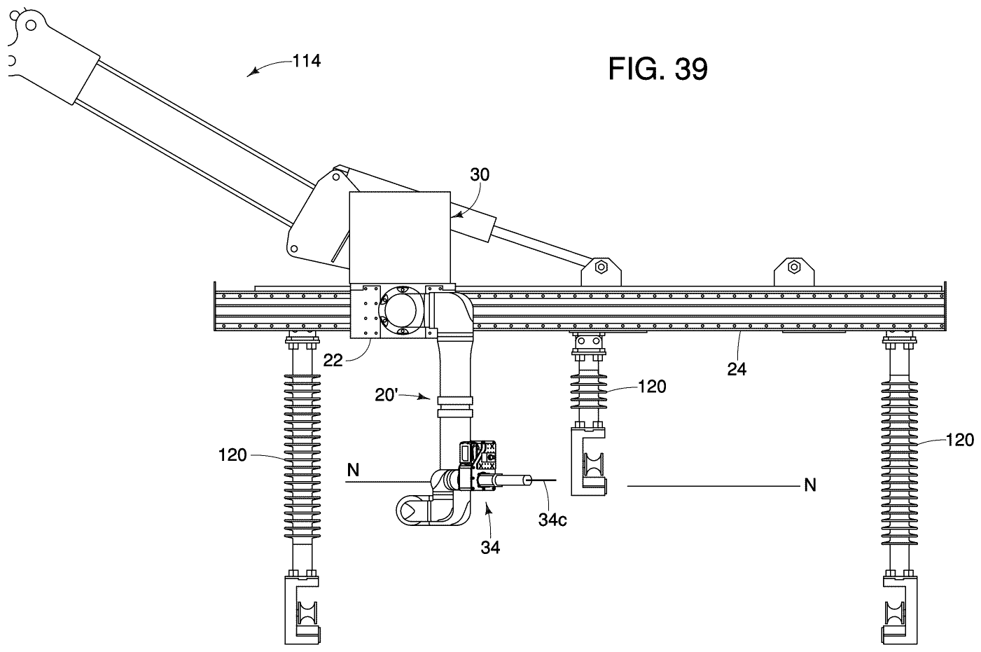

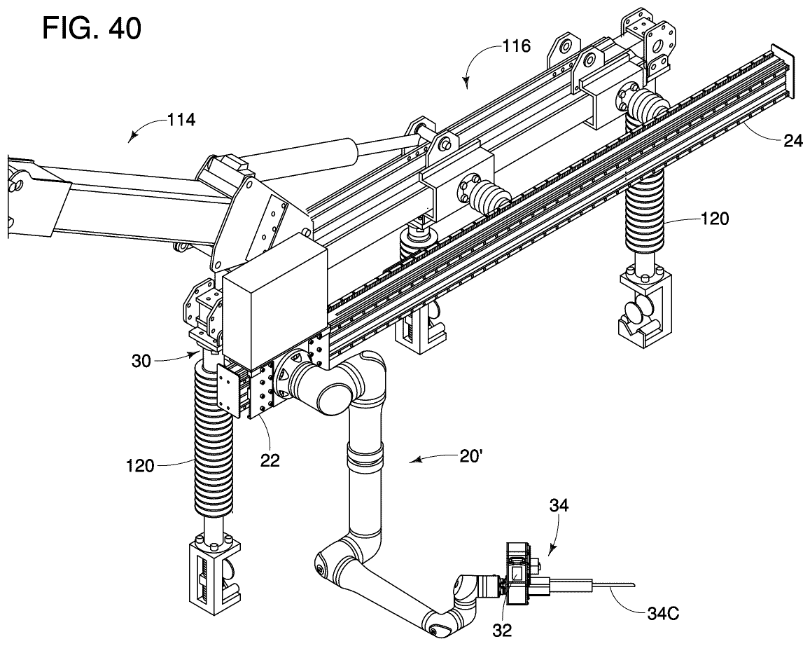

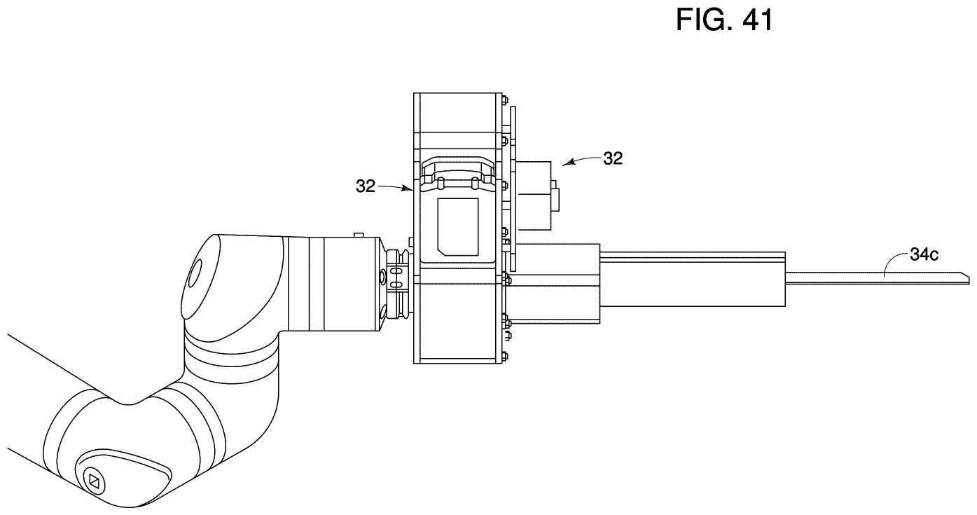

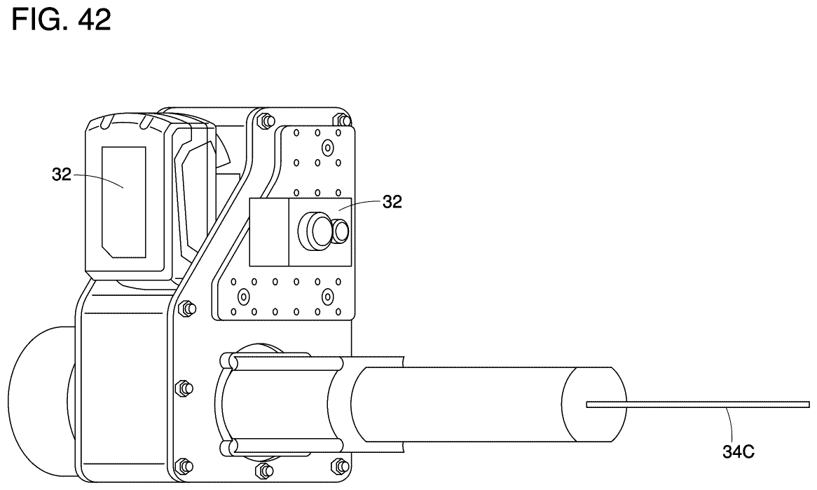

FIGS. 39-42 illustrate an example of a robotic manipulator arm 20′ having a reciprocating saw blade 34c, consistent with disclosed embodiments. As described above, reciprocating saw blade 34c may be used in, for example, a horizontal plane N (FIG. 39) to cut through old tie wire 18 that is wrapped around an insulator 14 (not shown in FIGS. 39-42). After a first horizontal cut is done from a first side of the insulator 14, saw blade 34c may be retracted, rotated by 180 degrees, and then brought back near insulator 14 and into cutting contact with tie wire 18 from the opposite side of the insulator 14.

### CLAUSES

Additional aspects of the present disclosure may be further described via the following clauses:

Clause 1. A robotic system for repairing or maintaining an electrical component connected to a conductor, the system comprising:
a sensor package configured to sense at least one parameter;
a robot, comprising:
   one or more robotic manipulator arms pivotally connected to the robot; and
   a logic unit configured to control the one or more robotic manipulator arms to perform a repair or maintenance operation;
a mechanical translator configured to position the robot along a slide rail; and
at least one insulator configured to releasably secure the conductor away from the electrical component,
wherein the system is mountable to an upper end of a truck or a crane boom, and
wherein the one or more robotic manipulator arms are positioned downwardly relative to the slide rail.

Clause 2. The system of clause 1, wherein the sensor package includes one or more of: a camera, a proximity sensor, a laser sensor, a Global Positioning System (GPS) sensor, a gyroscope sensor, an inertial measurement unit (IMU) sensor, or an accelerometer.

Clause 3. The system of clause 1 or 2, wherein the at least one parameter includes one or more of:
a location associated with one or more of: the electrical component, the conductor, the robot, or an obstacle;
a velocity associated with the robot;
an acceleration associated with the robot;
an orientation associated with the robot;
a distance between two of: the electrical component, the conductor, the robot, or the obstacle; or
an electromagnetic field change.

Clause 4. The system of any one of clauses 1-3, wherein the logic unit is further configured to determine, based on the sensed at least one parameter, one or more path plans for the robot.

Clause 5. The system of clause 4, wherein the mechanical translator is configured to position the robot at a position along the slide rail based on the determined one or more path plans.

Clause 6. The system of any one of clauses 1-5, wherein:
the one or more robotic manipulator arms are configured to connect to an effector, and
the effector includes one or more of: a gripper, a snipper, a wrench, pliers, a hand tool, a bond-on wand, a claw, or a heat source.

Clause 7. The system of any one of clauses 1-6, further comprising a beam pivotally mounted to the upper end of the truck or the crane boom, wherein:
the beam is connected to and parallel to the slide rail, and
the at least one insulator is connected to the beam and positioned downwardly relative to the beam.

Clause 8. The system of clause 7, wherein:
the beam is connected to the slide rail using at least one second insulator configured to electrically insulate the beam from the slide rail, and
the beam and the slide rail are offset by a length associated with the at least one second insulator.

Clause 9. The system of clause 7 or 8, wherein the beam includes one or more extendable telescopic arms configured to adjust a length of the beam.

Clause 10. The system of any one of clauses 1-9, wherein the slide rail is linear, bowed, curved, or non-linear.

Clause 11. The system of any one of clauses 1-10, wherein the mechanical translator is further configured to position the robot about and along a vertical axis orthogonal to the slide rail.

Clause 12. The system of any one of clauses 1-11, wherein the repair or maintenance operation includes one or more of:
releasing the electrical component from the conductor;
replacing the electrical component with a new electrical component; or
securing the electrical component to the conductor.

Clause 13. The system of clause 12, wherein releasing the electrical component includes untying a tie wire or unclamping the electrical component.

Clause 14. The system of clause 12 or 13, wherein securing the electrical component includes tying a tie wire or clamping the electrical component.

Clause 15. The system of any one of clauses 1-14, wherein the one or more robotic manipulator arms have seven or more degrees of freedom.

Clause 16. The system of any one of clauses 1-15, further comprising:
a coupler configured to mount the system to the upper end of the truck or the crane boom; and
a third insulator configured to electrically insulate the system from the upper end of the truck or the crane boom, wherein the third insulator is located between the system and the coupler.

Clause 17. A method for repairing or maintaining an electrical component connected to a conductor, comprising:
sensing, using a sensor package, at least one parameter;
determining, using at least one processor, one or more path plans for a robot based on the sensed at least one parameter, wherein the robot comprises one or more robotic manipulator arms;
positioning, using a mechanical translator, the robot at a position along a slide rail based on the determined one or more path plans; and
performing, using the one or more robotic manipulator arms, a repair or maintenance operation associated with the electrical component,
wherein the one or more robotic manipulator arms are positioned downwardly relative to the slide rail.

Clause 18. The method of clause 17, further comprising:
securing the conductor to at least one insulator; and
moving the at least one insulator away from the electrical component,
wherein the at least one insulator is positioned downwardly relative to the slide rail.

Clause 19. The method of clause 18, wherein the repair or maintenance operation includes one or more of:
releasing the electrical component from the conductor;
replacing the electrical component with a new electrical component; or
securing the electrical component to the conductor.

Clause 20. The method of clause 19, wherein releasing the electrical component from the conductor includes:
unwrapping, using the one or more robotic manipulator arms, a first end of a tie wire from the conductor; and
unwrapping, using the one or more robotic manipulator arms, a second end of the tie wire from the conductor.

Clause 21. The method of clause 19 or 20, wherein releasing the electrical component from the conductor includes:
cutting, using the one or more robotic manipulator arms, a tie wire securing the electrical component to the conductor.

Clause 22. The method of any one of clauses 19-21, wherein securing the electrical component to the conductor includes:
grasping, using the one or more robotic manipulator arms, a tie wire comprising a first end, a middle portion, and a second end;
wrapping, using the one or more robotic manipulator arms, the middle portion of the tie wire around the electrical component;
wrapping, using the one or more robotic manipulator arms, the first end of the tie wire around the conductor; and
wrapping, using the one or more robotic manipulator arms, the second end of the tie wire around the conductor.

Clause 23. A robotic system for repairing or maintaining an electrical component connected to a conductor, the system comprising:
a beam configured to be connected to an upper end of a truck or a crane boom; and
three insulator assemblies, each connected to the beam and comprising:
   a first insulator connected at a first end to the beam and positioned downwardly with respect to the beam;
   a robot connected at a first end of the robot to a second end of the beam, the robot comprising:
      one or more robotic manipulator arms pivotally connected to the robot; and
      a logic unit configured to control the one or more robotic manipulator arms to perform a repair or maintenance operation;
   a second insulator connected at a first end of the second insulator to a second end of the robot; and
   a wire cage connected to a second end of the second insulator and configured to releasably secure the conductor,
wherein each of the three insulator assemblies corresponds to a different conductor of a three phase circuit.

Clause 24. The system of clause 23, wherein the repair or maintenance operation includes one or more of:
releasing the electrical component from the conductor;
replacing the electrical component with a new electrical component; or
securing the electrical component to the conductor.

Clause 25. The system of clause 24, wherein releasing the electrical component includes untying a tie wire or unclamping the electrical component.

Clause 26. The system of clause 24 or 25, wherein securing the electrical component includes tying a tie wire or clamping the electrical component.

Clause 27. The system of any one of clauses 23-26, wherein the beam is an extendable telescopic beam.

Clause 28. A method for repairing or maintaining an electrical component connected to a conductor, comprising:
positioning, using at least an extendable telescopic beam, each of three insulator assemblies above a different conductor of a three phase circuit, wherein each insulator assembly comprises:
   a first insulator connected at a first end to the beam and positioned downwardly with respect to the beam;
   a robot connected at a first end of the robot to a second end of the beam, the robot comprising:
      one or more robotic manipulator arms pivotally connected to the robot; and
      a logic unit configured to control the one or more robotic manipulator arms to perform a repair or maintenance operation;
   a second insulator connected at a first end of the second insulator to a second end of the robot; and
   a wire cage connected to a second end of the second insulator and configured to releasably secure a corresponding conductor, and
performing, using the one or more robotic manipulator arms, a repair or maintenance operation associated with the corresponding electrical component,
wherein the three insulator assemblies are positioned downwardly relative to the beam, and
wherein each of the three insulator assemblies corresponds to a different conductor and electrical component of a three phase circuit.

Clause 29. The method of clause 28, further comprising:
securing, by each insulator assembly, the corresponding conductor to the corresponding wire cage; and
moving the corresponding wire cage away from the corresponding electrical component.

Clause 30. The method of clause 29, wherein the repair or maintenance operation includes one or more of:
releasing the corresponding electrical component from the corresponding conductor;
replacing the corresponding electrical component with a new electrical component;
securing the corresponding electrical component to the corresponding conductor; or
securing the new electrical component to the corresponding conductor.

Clause 31. The method of clause 30, wherein releasing the corresponding electrical component from the corresponding conductor includes:
unwrapping, using the corresponding one or more robotic manipulator arms, a first end of a tie wire from the corresponding conductor; and
unwrapping, using the corresponding one or more robotic manipulator arms, a second end of the tie wire from the corresponding conductor.

Clause 32. The method of clause 30 or 31, wherein releasing the corresponding electrical component from the corresponding conductor includes:
cutting, using the corresponding one or more robotic manipulator arms, a tie wire securing the corresponding electrical component to the corresponding conductor.

Clause 33. The method of any one of clauses 30-32, wherein securing the electrical component to the conductor includes:
grasping, using the corresponding one or more robotic manipulator arms, a tie wire comprising a first end, a middle portion, and a second end;
wrapping, using the corresponding one or more robotic manipulator arms, the middle portion of the tie wire around the corresponding electrical component;
wrapping, using the corresponding one or more robotic manipulator arms, the first end of the tie wire around the corresponding conductor; and
wrapping, using the corresponding one or more robotic manipulator arms, the second end of the tie wire around the corresponding conductor.

Clause 34. A robotic system for repairing or maintaining an electrical component connected to a conductor, the system comprising:
at least one insulator configured to be connected to an upper end of a truck or crane boom;
at least one wire cage configured to releasably secure the conductor; and
a robot pivotally connected to the at least one insulator, the robot comprising:
   one or more robotic manipulator arms pivotally connected to the robot; and
   a logic unit configured to control the one or more robotic manipulator arms to perform a repair or maintenance operation.

Clause 35. The system of clause 34, wherein the repair or maintenance operation includes one or more of:
unclamping the electrical component from the conductor;
replacing the electrical component with a new electrical component; or
clamping the electrical component to the conductor.

The foregoing descriptions have been presented for purposes of illustration. They are not exhaustive and are not limited to precise forms or embodiments disclosed. Modifications and adaptations of the embodiments will be apparent from consideration of the specification and practice of the disclosed embodiments. For example, the described implementations include hardware, but systems and methods consistent with the present disclosure can be implemented with hardware and software. In addition, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps or inserting or deleting steps.

It should be noted that, the relational terms herein such as “first” and “second” are used only to differentiate an entity or operation from another entity or operation, and do not require or imply any actual relationship or sequence between these entities or operations. These terms are used to distinguish one element from another. For example, a first element could be termed a second element, and, similarly, a second element could be termed a first element, without departing from the scope of the embodiments.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

As used herein, unless specifically stated otherwise, the terms “and/or” and “or” encompass all possible combinations, except where infeasible. For example, if it is stated that a system may include A or B, then, unless specifically stated otherwise or infeasible, the system may include A, or B, or A and B. As a second example, if it is stated that a system may include A, B, or C, then, unless specifically stated otherwise or infeasible, the database may include A, or B, or C, or A and B, or A and C, or B and C, or A and B and C.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the disclosure disclosed herein. It is intended that the specification and examples be considered as exemplary only, with a true scope and spirit of the disclosure being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

What is claimed is:

1. A robotic system for repairing or maintaining an electrical component connected to a conductor, the system comprising:
a sensor package configured to sense at least one parameter;
a robot, comprising:
one or more robotic manipulator arms pivotally connected to the robot; and
a logic unit configured to control the one or more robotic manipulator arms to perform a repair or maintenance operation;
a mechanical translator configured to position the robot along a slide rail; and
at least one insulator configured to releasably secure the conductor away from the electrical component,
wherein the system is mountable to an upper end of a truck or a crane boom, and
wherein the one or more robotic manipulator arms are positioned downwardly relative to the slide rail.

2. The system of claim 1, wherein the sensor package includes one or more of: a camera, a proximity sensor, a laser sensor, a Global Positioning System (GPS) sensor, a gyroscope sensor, an inertial measurement unit (IMU) sensor, or an accelerometer.

3. The system of claim 1, wherein the at least one parameter includes one or more of:
a location associated with one or more of: the electrical component, the conductor, the robot, or an obstacle;
a velocity associated with the robot;
an acceleration associated with the robot;
an orientation associated with the robot;
a distance between two of: the electrical component, the conductor, the robot, or the obstacle; or
an electromagnetic field change.

4. The system of claim 1, wherein the logic unit is further configured to determine, based on the sensed at least one parameter, one or more path plans for the robot.

5. The system of claim 4, wherein the mechanical translator is configured to position the robot at a position along the slide rail based on the determined one or more path plans.

6. The system of claim 1, wherein:
the one or more robotic manipulator arms are configured to connect to an effector, and
the effector includes one or more of: a gripper, a snipper, a wrench, pliers, a hand tool, a bond-on wand, a claw, or a heat source.

7. The system of claim 1, further comprising a beam pivotally mounted to the upper end of the truck or the crane boom, wherein:
the beam is connected to and parallel to the slide rail, and
the at least one insulator is connected to the beam and positioned downwardly relative to the beam.

8. The system of claim 7, wherein:
the beam is connected to the slide rail using at least one second insulator configured to electrically insulate the beam from the slide rail, and
the beam and the slide rail are offset by a length associated with the at least one second insulator.

9. The system of claim 7, wherein the beam includes one or more extendable telescopic arms configured to adjust a length of the beam.

10. The system of claim 1, wherein the slide rail is linear, bowed, curved, or non-linear.

11. The system of claim 1, wherein the mechanical translator is further configured to position the robot about and along a vertical axis orthogonal to the slide rail.

12. The system of claim 1, wherein the repair or maintenance operation includes one or more of:
releasing the electrical component from the conductor;
replacing the electrical component with a new electrical component; or
securing the electrical component to the conductor.

13. The system of claim 12, wherein releasing the electrical component includes untying a tie wire or unclamping the electrical component.

14. The system of claim 12, wherein securing the electrical component includes tying a tie wire or clamping the electrical component.

15. The system of claim 1, wherein the one or more robotic manipulator arms have seven or more degrees of freedom.

16. The system of claim 1, further comprising:
a coupler configured to mount the system to the upper end of the truck or the crane boom; and
a third insulator configured to electrically insulate the system from the upper end of the truck or the crane boom, wherein the third insulator is located between the system and the coupler.

17. A method for repairing or maintaining an electrical component connected to a conductor, comprising:
sensing, using a sensor package, at least one parameter;
determining, using at least one processor, one or more path plans for a robot based on the sensed at least one parameter, wherein the robot comprises one or more robotic manipulator arms;
positioning, using a mechanical translator, the robot at a position along a slide rail based on the determined one or more path plans; and
performing, using the one or more robotic manipulator arms, a repair or maintenance operation associated with the electrical component,
wherein the one or more robotic manipulator arms are positioned downwardly relative to the slide rail.

18. The method of claim 17, further comprising:
securing the conductor to at least one insulator; and
moving the at least one insulator away from the electrical component,
wherein the at least one insulator is positioned downwardly relative to the slide rail.

19. The method of claim 18, wherein the repair or maintenance operation includes one or more of:
releasing the electrical component from the conductor;
replacing the electrical component with a new electrical component; or
securing the electrical component to the conductor.

20. The method of claim 19, wherein releasing the electrical component from the conductor includes:
unwrapping, using the one or more robotic manipulator arms, a first end of a tie wire from the conductor; and
unwrapping, using the one or more robotic manipulator arms, a second end of the tie wire from the conductor.

21. The method of claim 19, wherein releasing the electrical component from the conductor includes:
cutting, using the one or more robotic manipulator arms, a tie wire securing the electrical component to the conductor.

22. The method of claim 19, wherein securing the electrical component to the conductor includes:
grasping, using the one or more robotic manipulator arms, a tie wire comprising a first end, a middle portion, and a second end;
wrapping, using the one or more robotic manipulator arms, the middle portion of the tie wire around the electrical component;
wrapping, using the one or more robotic manipulator arms, the first end of the tie wire around the conductor; and
wrapping, using the one or more robotic manipulator arms, the second end of the tie wire around the conductor.

23. A robotic system for repairing or maintaining an electrical component connected to a conductor, the system comprising:
a beam configured to be connected to an upper end of a truck or a crane boom; and
three insulator assemblies, each connected to the beam and comprising:
a first insulator connected at a first end to the beam and positioned downwardly with respect to the beam;
a robot connected at a first end of the robot to a second end of the beam, the robot comprising:
one or more robotic manipulator arms pivotally connected to the robot; and
a logic unit configured to control the one or more robotic manipulator arms to perform a repair or maintenance operation;
a second insulator connected at a first end of the second insulator to a second end of the robot; and
a wire cage connected to a second end of the second insulator and configured to releasably secure the conductor,
wherein each of the three insulator assemblies corresponds to a different conductor of a three phase circuit.

24. The system of claim 23, wherein the repair or maintenance operation includes one or more of:
releasing the electrical component from the conductor;
replacing the electrical component with a new electrical component; or
securing the electrical component to the conductor.

25. The system of claim 24, wherein releasing the electrical component includes untying a tie wire or unclamping the electrical component.

26. The system of claim 24, wherein securing the electrical component includes tying a tie wire or clamping the electrical component.

27. The system of claim 23, wherein the beam is an extendable telescopic beam.
